(19) United States
(12) Patent Application Publication
(10) Pub. No.: US 2026/0077726 A1
(43) Pub. Date: Mar. 19, 2026

(54) VEHICLE SEAT AND MANUFACTURING METHOD FOR VEHICLE SEAT

(71) Applicant: TS TECH CO., LTD., Asaka-shi, Saitama (JP)

(72) Inventors: Wataru HIRATSUKA, Tochigi (JP); Yuki OSHIMA, Tochigi (JP)

(21) Appl. No.: 19/109,976

(22) PCT Filed: Jan. 31, 2024
(86) PCT No.: PCT/JP2024/003104

§ 371 Date: Mar. 7, 2025

Related U.S. Application Data
(60) Provisional application No. 63/511,018, filed on Jun. 29, 2023.

(30) Foreign Application Priority Data
Aug. 14, 2023 (JP) 2023-132030
Aug. 22, 2023 (JP) 2023-134668
Aug. 22, 2023 (JP) 2023-134694
Sep. 12, 2023 (JP) 2023-147834

(51) Int. Cl. B60R 16/02; B60N 2/68

(52) U.S. Cl. CPC B60R 16/0215; B60N 2/68

(57) ABSTRACT

The vehicle seat includes a frame structure, a support member supported by the frame structure, a pad member supported on a front side of the support member, and an electrical device connected to a wire harness, the support member having a plate-shaped support member main body, and a retaining structure for retaining the wire harness on the main body, wherein the retaining structure includes a first retaining portion that connects the wire harness to the main body so as to be movable in a first direction and immobile in a second direction crossing the first direction, and a second retaining portion that connects the wire harness to the main body so as to be movable in the second direction and immobile in the first direction, the retaining structure being integrally formed with the main body.

### TECHNICAL FIELD

The present invention relates to a vehicle seat and a manufacturing method for a vehicle seat.

### BACKGROUND ART

Patent Document 1 discloses a vehicle seat. The seat cushion of this vehicle seat includes a frame structure and a support member that is supported by the frame structure and elastically supports the weight of an occupant. The support member includes a plate-shaped main body that extends substantially parallel to the frame structure and a pair of inclined portions that extends outward from either side edge of the main body. The inclined portions are provided with tubular portions each formed with an attachment hole through which a clip for attaching a member, such as a wire harness or a wire member such as a cable, to the support member is inserted.

Patent Document 2 discloses a cable fixing element in a spring mat for a vehicle seat. The fixing element includes a retaining region and an arm that elastically applies a load to the cable to press the cable against the retaining region and secure the cable to the retaining region.

### PRIOR ART DOCUMENT(S)

### Patent Document(s)

Patent Document 1: JP2020-124976A
Patent Document 2: JP2015-503490A

### SUMMARY OF THE INVENTION

### Task to be Accomplished by the Invention

The support member (which may also be called as a pressure-receiving member) provided in the vehicle seat moves when it receives the load of the seated occupant. Therefore, there is a need for a vehicle seat that can retain a wire member such as a cable on the support member while minimizing the load that may be applied to the wire member when the support member moves.

### Means to Accomplish the Task

In view of the above background, a primary object of the present invention is to provide a vehicle seat including a support member that supports the load from the occupant and an electrical device to which a wire member such as a cable is connected in such a manner that the wire member can be retained on the support member so as to minimize the load applied to the wire member when the support member moves, and a method for manufacturing such a vehicle seat.

To accomplish such a task, one aspect of the present invention provides a vehicle seat (1), comprising a frame structure (8), a support member (17) supported by the frame structure and supporting an occupant, a pad member (9A) supported on a front side of the support member, and a wire harness (27) to be connected to an electrical device (24), the support member having a plate-shaped main body (18), and a retaining structure (50) for retaining the wire harness on the main body, wherein the retaining structure includes a first retaining portion (51) that connects the wire harness to the main body so as to be movable in a first direction and immobile in a second direction crossing the first direction, and a second retaining portion (52) that connects the wire harness to the main body so as to be movable in the second direction and immobile in the first direction, the retaining structure being integrally formed with the main body.

According to this aspect, the wire harness is retained by the support member at the first retaining portion so as to be movable in the first direction, and is retained by the support member at the second retaining portion so as to be movable in the second direction. This allows the wire harness to move so that the load that may be applied to the wire harness when the support member moves can be reduced. Thus, it is possible to provide a vehicle seat that can retain the wire harness on the support member while reducing the load that may be applied to the wire harness.

In the above aspect, preferably, the first retaining portion includes a pair of first base portions (53) that protrude from a rear surface of the main body and are aligned in the second direction, and the second retaining portion includes a pair of second base portions (55) that protrude from a rear surface of the main body and are aligned in the first direction, the wire harness being passed between the first base portions and between the second base portions.

According to this aspect, the first retaining portion can restrict movement of the wire harness in the second direction while allowing movement of the wire harness in the first direction. Furthermore, the second retaining portion can restrict movement of the wire harness in the first direction while permitting movement of the wire harness in the second direction.

In the above aspect, preferably, at least one of the first base portions and at least one of the second base portions are connected to each other.

According to this aspect, movement of the wire harness can be restricted more firmly than when the first base portion and the second base portion are not connected.

In the above aspect, preferably, the first base portions and the second base portions are positioned apart from each other.

According to this aspect, the wire harness is more easily deformed between the first retaining portions and the second retaining portions than when the first base portions and the second base portions are connected to each other so that stress concentration on the wire harness in the part thereof located between the first retaining portions and the second retaining portions can be avoided.

In the above aspect, preferably, each first base portion is plate-shaped having a surface perpendicular to the second direction, and each second base portion is plate-shaped having a surface perpendicular to the first direction.

According to this aspect, the first retaining portions can effectively restrict movement of the wire harness in the first direction. Also, the second retaining portions can effectively restrict movement of the wire harness in the second direction.

In the above aspect, preferably, the first base portions are provided at a position spaced apart from the second base portions in both the first direction and the second direction.

According to this aspect, stress that may be applied to the part of the wire harness located between the first retaining portion and the second retaining portion can be minimized.

In the above aspect, preferably, a tip of each of the first base portions and the second base portion is provided with a restricting piece (54, 56) to restrict the wire harness from moving away from the main body.

According to this aspect, movement of the wire harness in a direction away from the main body can be restricted.

In the above aspect, preferably, the first base portion is plate-shaped having a surface perpendicular to the second direction, and at least one of the first base portions is provided with two or more restricting pieces such that the restricting pieces provided on the one first base portion and the restricting piece provided on the other first base portion are arranged in a staggered manner along the first direction.

According to this aspect, the wire harness can be easily inserted between the two first base portions, improving the ease of assembling the wire harness to the support member.

In the above aspect, preferably, each second base portion is plate-shaped having a surface perpendicular to the first direction, and at least one of the second base portions is provided with two or more restricting pieces such that the restricting pieces provided on the one second base portion and the restricting piece provided on the other second base portion are arranged in a staggered manner along the second direction.

According to this aspect, since it is easier to insert the wire harness between the two second base portions, the workability of assembling the support member for the wire harness is improved.

In the above aspect, preferably, opposing surfaces of the first base portions are provided with protrusions (70) that protrude in opposing directions, at least one of the first base portions being provided with a plurality of the protrusions such that the protrusions are staggered along the first direction, and the protrusion amount of each protrusion increase as one moves away from the support member.

According to this aspect, the protrusion amount of the protrusions increases as one moves away from the support member. Therefore, when the wire harness is pulled by the electrical device such as a vibration generating device is pulled and is pressed against the support member, the movement of the wire harness in the second direction becomes less restricted so that the load that may be applied to the wire harness can be reduced.

To accomplish such a task, one aspect of the present invention provides a method for manufacturing a vehicle seat (1) comprising the steps of installing a pad member (9A) on a front side of a support member (17) supported by a frame structure (8) and installing an electrical device (24) to which a wire harness (27) is connected on the pad member (9A), the support member having a plate-shaped main body (18) and a retaining structure (50) for retaining the wire harness on the main body, wherein the retaining structure includes a first retaining portion (51) that connects the wire harness to the main body so as to be movable in a first direction and immobile in a second direction crossing the first direction, and a second retaining portion (52) that connects the wire harness to the main body so as to be movable in the second direction and immobile in the first direction, and the step of installing the electrical device includes the steps of retaining the wire harness to the first retaining portion and the second retaining portion.

According to this aspect, the wire harness is retained by the support member at the first retaining portion so as to be movable in the first direction, and is retained by the support member at the second retaining portion so as to be movable in the second direction. This allows the wire harness to move so that the load that may be applied to the wire harness when the support member moves can be reduced. Thus, it is possible to provide a method for manufacturing a vehicle seat that can retain the wire harness on the support member while reducing the load that may be applied to the wire harness.

Further, the above-mentioned Patent Document 1 (JP 2020-124976A) discloses a vehicle seat in which a vibration device is provided in the seat back. A pair of recesses, which are open on the rear side and closed on a front side, are formed laterally next to each other in the seat in the back pad of the seat back. Each recess receives a vibration device from the rear to be retained therein.

The vibration devices of Patent Document 1 are fitted into the recesses provided in the back pad and are retained in the back pad by being frictionally engaged by the wall surface defining the recesses. Therefore, for example, if the wall surface defining the recess is deformed by the load from the occupant, there is a risk that the vibration devices may move relative to the back pad.

In view of the above background, a primary object of the present invention is to provide a vehicle seat and a seat pad provided in the vehicle seat capable of retaining an electrical device therein, and a method for manufacturing such a vehicle seat.

To accomplish such an object, one aspect of the present invention provides a vehicle seat (1), comprising a pad member (9A) provided with a recess (22), an electrical device (24) received in the recess, and an engagement member (30) that engages with the electrical device inside the recess, wherein the recess is defined by a bottom wall (22B) and an upright wall (22S) extending from the bottom wall, and the engagement member is fixed to the pad member at a position closer to an opening of the recess than the bottom wall, the engagement member being more rigid than the pad member.

According to this aspect, the electrical device is coupled to the pad member via the engagement member. Since the engagement member is more rigid and less likely to deform than the pad member, a vehicle seat can be provided that can retain the electrical device in a more stable manner than in a case where the electrical device is supported by the pad member directly contacting the electrical device.

In the above aspect, preferably, the seat further includes a covering member (42) covering a front side of the electrical device, the recess opens toward a front side of the pad member, and the covering member is housed inside the recess, so that a surface of the covering member is flush with a surface of a peripheral part of the recess of the pad member.

In this aspect, a step is prevented from being created between the surface of the peripheral part of the recess of the pad member and the surface of the covering member. This prevents the seat occupant from experiencing discomfort from the peripheral part of the recess of the pad member.

In the above aspect, preferably, the engagement member is provided with a locking claw that resiliently engages with a side of the electrical device.

In this aspect, the electrical device can be engaged with the engagement member with a simple configuration.

In the above aspect, preferably, the electrical device is provided with a locking recess (37A) that receives the locking claw.

According to this aspect, the engagement member and the electrical device can be engaged firmly.

In the above aspect, preferably, the engagement member includes an engagement member main body (31) that supports the locking claw, the engagement member main body being shaped like a frame into which the electrical device is received, and at least a part of the engagement member main body is provided with a cutout (40).

According to this aspect, the engagement member is easily deformed so that assembling of the electrical device to the engagement member can be facilitated.

In the above aspect, preferably, the engagement member main body is formed as a rectangular frame structure having four corner portions (33), and the cutout is provided at one of the corner portions.

According to this aspect, the engagement member is easily deformed.

In the above aspect, preferably, the locking claw is provided at a position adjacent to one of the cutouts.

According to this aspect, the engagement member is more easily deformed than when the locking claw is provided at a position away from the cutout.

In the above aspect, preferably, the engagement member is insert molded in the pad member.

According to this aspect, the engagement member can be attached to the pad member.

To accomplish such an object, another aspect of the present invention provides a seat pad (9) for forming a vehicle seat (1) fitted with an electrical device (24), comprising: a pad member (9A) having a recess (22) into which the electrical device is to be inserted; and an engagement member (30) attached to a wall surface defining the recess to engage the electrical device, wherein the recess is defined by a bottom wall (22B) and an upright wall (22S) extending upright from the bottom wall, and the engagement member is fixed to a part of the pad member nearer to an opening of the recess that to the bottom wall, the engagement member being more rigid than the pad member.

According to this aspect, the electrical device is connected to the pad member via the engagement member. Since the engagement member is more rigid than the pad member and is less likely to deform, a seat pad can be provided that can hold the electrical device in a more stable manner than when the pad member is in direct contact with the electrical device.

To accomplish such an object, yet another aspect of the present invention provides a manufacturing method for a vehicle seat (1), comprising the steps of molding a pad member such that an engagement member (30) configured to engage an electrical device (24) is attached to a wall surface defining a recess (22) formed in the pad member (9A); inserting the electrical device into the recess to secure the electrical device to the pad member; covering the electrical device with a covering member (42); attaching the pad member to a frame structure (8); and covering a surface of the pad member and a surface of the covering member with a skin material (10), the engagement member having higher rigidity than the pad member.

According to this aspect, the electrical device is attached to the pad member via the engagement member. Since the engagement member is more rigid and less prone to deformation than the pad member, this manufacturing method for a vehicle seat can secure the electrical device in a more stable manner than when the electrical device is supported by the pad member that directly contacts the electrical device.

JP 2018-070075 A discloses a vehicle seat having vibration members (vibration devices) and air cells. The vibration members are provided on the surface (back surface) of a seat pad provided inside the seat main body, opposite from the surface (front surface) that supports the occupant. The air cells are provided on the surface of the seat pad that supports the occupant so as to oppose the vibration member.

When the air cells and the vibration devices are arranged on the surface of the seat pad, there is a risk that the air cells and vibration devices are arranged in an overly crowded manner. Since the surface area of the seat pad is limited, it is difficult to accommodate the air cells and vibration devices on the surface of the seat pad.

Therefore, there is a challenge to be overcome when arranging vibration devices and air cells on the surface of the seat pad of a vehicle seat.

To solve the above problem, the present invention provides a vehicle seat (101) comprising a frame structure (111), a pad (112) supported by the frame structure, at least one vibration device (107) positioned on a front side of the pad, and at least one air cell (108) positioned on the front side of the pad, the air cell and the vibration device overlapping each other when viewed from a thickness direction of the pad.

According to this aspect, the vibration devices and the air cells can be arranged so as to be densely packed together when viewed from the thickness direction of the pad. Therefore, the air cells and the vibration devices can be favorably arranged on the surface of the pad.

In the above aspect, the pad has at least one first recess (141) recessed from a front surface of the pad to the rear side to receive the vibration device therein, and the air cell is positioned closer to the front side of the pad than the vibration device.

According to this aspect, the vibration device is unlikely to come into contact with the occupant, and discomfort to the occupant is minimized.

In the above aspect, preferably the air cell is fixed to the pad via a fixing member (143).

According to this aspect, the air cell can be fixed to the pad.

In the above aspect, preferably, the at least one air cell includes a pair of air cells positioned spaced apart from each other, a spacer (144) is positioned between the two air cells, and the vibration device overlaps the spacer and the two vibration devices when viewed in a thickness direction of the pad.

According to this aspect, since the spacer fills the space between the two air cells, the vibration of the vibration device is efficiently transmitted to the occupant.

In the above aspect, preferably, each air cell is configured to be inflated by supplying fluid thereto and contracted by discharging fluid therefrom, and the spacer has a surface that is flush with a surface of the air cells in a contracted state.

According to this aspect, steps that may be created between the spacer and the air cells are minimized. Therefore, discomfort to the occupant can be further reduced.

In the above aspect, preferably, the vehicle seat further includes an air blower (109) provide with an air blower which includes an air blower main body (131) and a duct (132) connected to the air blower main body, wherein the pad further includes a ventilation hole (134) passed through the pad in a thickness direction thereof and communicated with the duct, and a ventilation groove (135) connected to the ventilation hole, recessed from a surface of the pad toward a back side thereof, and extending along the surface of the pad, and the at least one first recess is communicated with the ventilation groove.

According to this aspect, the vibration device and the ventilation groove can be arranged so as to be closely packed together when viewed from the thickness direction of the pad. Therefore, in addition to the air cell and the vibration device, the ventilation groove can also be arranged on the surface of the pad in a favorable manner.

In the above aspect, preferably, a width of the ventilation groove is smaller than a width of the first recess.

According to this aspect, when the vibration device is housed in the first recess, the vibration device blocks a part of the opening of the ventilation groove. Therefore, air passing through the ventilation groove is prevented from leaking out of the first recess.

In the above aspect, preferably, a cover pad (146) is placed on the front side of the pad so as to cover the ventilation groove, and is provided with a plurality of through holes (148) that overlap the ventilation groove when viewed from the thickness direction of the pad.

According to this aspect, the cover pad cooperates with the pad to form a flow passage for air forwarded from the blower main body.

In the above aspect, preferably, the cover pad is provided with a plurality of second recesses (151) recessed from a rear surface of the cover pad toward a front surface thereof, and the two air cells are received in the second recesses (151).

According to this aspect, each air cell is prevented from moving in a direction parallel to the surface of the pad.

To accomplish such an object, yet another aspect of the present invention provides a method for manufacturing a vehicle seat (101) including a frame structure (111), a pad (112) supported by the frame structure, at least one vibration device (107) positioned on a front side of the pad, a pair of air cells (108) arranged on the front side of the pad at a distance from each other, a spacer (144) positioned between the two air cells, and a fixing member (143) for fixing the two air cells to the pad, the pad having at least one first recess (141) recessed from the front surface of the pad toward the back side, the method comprising a first step of receiving the vibration device in the first recess; a second step of placing the fixing member on the front side of the pad; a third step of fixing the two air cells to the fixing member so as to overlap with the vibration device when viewed from a thickness direction of the pad; and a fourth step of placing the spacer between the two air cells.

According to this aspect, a vehicle seat is manufactured such that the vibration device and the air cells are positioned on the surface of the pad.

JP2019-167115A discloses an automatic drive control device that notifies the occupant when the driving mode is switched from an automatic driving mode to a manual driving mode. The seat on which the occupant is seated is vibrated as an example of such a notification.

However, JP2019-167115A does not specifically disclose the vibration mode of the seat. Therefore, there is a risk that the occupant may not be able to recognize the switching of the driving mode simply by vibrating the seat.

Therefore, there is a task to make the occupant aware of the switch in driving modes in a vehicle by the vibration of the seat.

To accomplish such an object, yet another aspect of the present invention provides a vehicle (201) having a vehicle control device (226) that switches a driving mode between an automatic driving mode and a manual driving mode, a first seat (22A) that serves as a driver's seat and is equipped with a plurality of vibration devices (220), and a seat control device (225) that controls the vibration devices, wherein the seat control device executes a notification control to vibrate the vibration devices in order from those located in rear to those located in front when the vehicle control device executes an automatic driving end control to switch the driving mode from the automatic driving mode to the manual driving mode.

According to this aspect, the vibration devices vibrate in order from those located in rear to those located in front so that the occupant is alerted to look ahead in a reliable manner. As a result, in the vehicle, the mode of vibration of the first seat can make the occupant accurately aware of the switch in driving mode.

In the above aspect, preferably, the first seat may be provided on a floor (204) of the vehicle via a rotation device (211) which supports the first seat so as to be rotatable around a vertically extending rotational axis relative to the floor, and the seat control device is configured to determine front-rear positions of the vibration devices base by taking into account the rotational angle of the first seat around the rotational axis.

According to this aspect, even if the seat is rotated by the rotation device, the front-rear positions of each vibration device can be determined in a reliable manner.

In the above aspect, preferably, the first seat is provided with a seat cushion (205) and a seat back (206) extending upward from a rear part of the seat cushion, and the plurality of vibration devices are provided on the seat cushion and the seat back.

According to this aspect, the distance between the frontmost vibration device and the rearmost vibration device can be increased so that the moving distance of the vibrating position can be increased.

In the above aspect, preferably, the seat control device is configured to drive the rotation device so that the first seat faces forward when the first seat faces backward and the vehicle control device executes the automatic driving end control.

According to this aspect, when switching from the automatic driving mode to the manual driving mode, the first seat is caused to face forward so that the occupant can prepare for manual driving.

In the above aspect, preferably, an input device (253) for receiving manual driving operations is provided, and the seat control device is configured to stop vibration of the vibration devices when a predetermined input operation is applied to the input device during execution of the notification control.

According to this aspect, it is possible to estimate that the occupant is ready for the manual driving mode based on the input to the input device by the occupant. Furthermore, when the occupant is ready for the manual driving mode, unnecessary energy consumption can be avoided by stopping vibration of the vibration device.

In the above aspect, preferably, the vehicle control device is configured to defer the manual driving mode from starting while the vibration devices are vibrating due to the notification control, and start the manual driving mode after the vibration devices have stopped vibrating.

According to this aspect, the driving mode is switched from the automatic driving mode to the manual driving mode only after the occupant has completed preparation for the manual driving mode so that the safety of the vehicle is enhanced.

In the above aspect, preferably, the vehicle is provided with a second seat (202B) fitted with another vibration device, and the seat control device is configured to activate the other vibration device of the second seat when the vibration of the vibration devices of the first device has persisted for a predetermined time in the notification control.

According to this aspect, when the occupant seated in the first seat does not respond to the switching of the driving mode, a notification can be given to the occupant seated in the second seat.

In the above aspect, preferably, the vehicle further comprises a voice control device (227) that controls a speaker (255) based on voice information, and the seat control device is configured to execute an additional control so as to control the vibration devices based on the voice information and reduce the amplitude of the vibration of the vibration devices by the additional control when the notification control is executed as compared to when the notification control is not executed.

In this aspect, when the driving mode is switched, the amplitude by the additional control is suppressed, making it easier for the occupant to recognize the vibration by the notification control.

In the above aspect, preferably, the vehicle is provided with an obstacle sensor (251) that detects obstacles around the vehicle, the seat control device is configured to execute an obstacle control to control the vibration devices depending on a position of an obstacle, and the seat control device is configured to prohibit the obstacle control when the notification control is being executed.

According to this aspect, when the driving mode is switched, the obstacle control is prohibited, making it easier for the occupant to recognize the vibration caused by the notification control.

In the above aspect, preferably, the vibration devices include an eccentric rotating mass vibration motor and a linear resonant actuator.

In the above aspect, the occupant can distinguish the notification depending on if the vibration is caused by the eccentric rotating mass vibration motor or the linear resonant actuator.

In the above aspect, preferably, the seat control device is configured to execute a preliminary control for vibrating the vibration devices at an amplitude smaller than the amplitude of the vibration devices in the notification control before executing the notification control.

According to this aspect, the occupant can recognize that the driving mode has been switched from the vibration based on the preliminary control.

In the above aspect, preferably, the seat back is supported so as to be tiltable relative to the seat cushion, and the seat control device increases an amplitude of an output of the vibration devices in the notification control when a reclining angle of the seat back with respect to a vertical plane is equal to or greater than a predetermined first determination value as compared to when the reclining angle is less than the first determination value.

According to this aspect, a larger vibration can be applied to the occupant who may be asleep so that the occupant may be made aware of the change in driving mode.

In the above aspect, preferably, the seat cushion is provided with a load sensor that measures a load received from the occupant, and the seat control device is configured to, in the notification control, increase an amplitude of the vibration devices when the load measured by the load sensor is equal to or greater than a predetermined second determination value as compared to when the load measured by the load sensor is less than the second determination value.

According to this aspect, a larger vibration can be applied to the occupant who is of a larger build.

### Effect of the Invention

To accomplish such a task, one aspect of the present invention provides a vehicle seat (1), comprising a frame structure (8), a support member (17) supported by the frame structure and supporting an occupant, a pad member (9A) supported on a front side of the support member, and a wire harness (27) to be connected to an electrical device (24), the support member having a plate-shaped main body (18) and a retaining structure (50) for retaining the wire harness on the main body, wherein the retaining structure includes a first retaining portion (51) that connects the wire harness to the main body so as to be movable in a first direction and immobile in a second direction crossing the first direction, and a second retaining portion (52) that connects the wire harness to the main body so as to be movable in the second direction and immobile in the first direction, the retaining structure being integrally formed with the main body.

According to this aspect, the wire harness is retained by the support member at the first retaining portion so as to be movable in the first direction, and is retained by the support member at the second retaining portion so as to be movable in the second direction. This allows the wire harness to move so that the load that may be applied to the wire harness when the support member moves can be reduced. Thus, it is possible to provide a vehicle seat that can retain the wire harness on the support member while reducing the load that may be applied to the wire harness.

In the above aspect, preferably, the first retaining portion includes a pair of first base portions (53) that protrude from a rear surface of the main body and are aligned in the second direction, and the second retaining portion includes a pair of second base portions (55) that protrude from a rear surface of the main body and are aligned in the first direction, the wire harness being passed between the first base portions and between the second base portions.

According to this aspect, the first retaining portion can restrict movement of the wire harness in the second direction while allowing movement of the wire harness in the first direction. Furthermore, the second retaining portion can restrict movement of the wire harness in the first direction while permitting movement of the wire harness in the second direction.

In the above aspect, preferably, at least one of the first base portions and at least one of the second base portions are connected to each other.

According to this aspect, movement of the wire harness can be restricted more firmly than when the first base portion and the second base portion are not connected.

In the above aspect, preferably, the first base portions and the second base portions are positioned apart from each other.

According to this aspect, the wire harness is more easily deformed between the first retaining portions and the second retaining portions than when the first base portions and the second base portions are connected to each other so that stress concentration on the wire harness in the part thereof located between the first retaining portions and the second retaining portions can be avoided.

In the above aspect, preferably, each first base portion is plate-shaped having a surface perpendicular to the second direction, and each second base portion is plate-shaped having a surface perpendicular to the first direction.

According to this aspect, the first retaining portions can effectively restrict movement of the wire harness in the first direction. Also, the second retaining portions can effectively restrict movement of the wire harness in the second direction.

In the above aspect, preferably, the first base portions are provided at a position spaced apart from the second base portions in both the first direction and the second direction.

According to this aspect, stress that may be applied to the part of the wire harness located between the first retaining portion and the second retaining portion can be minimized.

In the above aspect, preferably, a tip of each of the first base portions and the second base portion is provided with a restricting piece (54, 56) to restrict the wire harness from moving away from the main body.

According to this aspect, movement of the wire harness in a direction away from the main body can be restricted.

In the above aspect, preferably, the first base portion is plate-shaped having a surface perpendicular to the second direction, and at least one of the first base portions is provided with two or more restricting pieces such that the restricting pieces provided on the one first base portion and the restricting piece provided on the other first base portion are arranged in a staggered manner along the first direction.

According to this aspect, the wire harness can be easily inserted between the two first base portions, improving the ease of assembling the wire harness to the support member.

In the above aspect, preferably, each second base portion is plate-shaped having a surface perpendicular to the first direction, and at least one of the second base portions is provided with two or more restricting pieces such that the restricting pieces provided on the one second base portion and the restricting piece provided on the other second base portion are arranged in a staggered manner along the second direction.

According to this aspect, since it is easier to insert the wire harness between the two second base portions, the workability of assembling the support member for the wire harness is improved.

In the above aspect, preferably, opposing surfaces of the first base portions are provided with protrusions (70) that protrude in opposing directions, at least one of the first base portions being provided with a plurality of the protrusions such that the protrusions are staggered along the first direction, and the protrusion amount of each protrusion increase as one moves away from the support member.

According to this aspect, the protrusion amount of the protrusions increases as one moves away from the support member. Therefore, when the wire harness is pulled by the electrical device such as a vibration generating device is pulled and is pressed against the support member, the movement of the wire harness in the second direction becomes less restricted so that the load that may be applied to the wire harness can be reduced.

To accomplish such a task, one aspect of the present invention provides a method for manufacturing a vehicle seat (1) comprising the steps of installing a pad member (9A) on a front side of a support member (17) supported by a frame structure (8) and installing an electrical device (24) to which a wire harness (27) is connected on the pad member (9A), the support member having a plate-shaped main body (18) and a retaining structure (50) for retaining the wire harness on the main body, wherein the retaining structure includes a first retaining portion (51) that connects the wire harness to the main body so as to be movable in a first direction and immobile in a second direction crossing the first direction, and a second retaining portion (52) that connects the wire harness to the main body so as to be movable in the second direction and immobile in the first direction, and the step of installing the electrical device includes the steps of retaining the wire harness to the first retaining portion and the second retaining portion.

According to this aspect, the wire harness is retained by the support member at the first retaining portion so as to be movable in the first direction, and is retained by the support member at the second retaining portion so as to be movable in the second direction. This allows the wire harness to move so that the load that may be applied to the wire harness when the support member moves can be reduced. Thus, it is possible to provide a method for manufacturing a vehicle seat that can retain the wire harness on the support member while reducing the load that may be applied to the wire harness.

To accomplish such an object, one aspect of the present invention provides a vehicle seat (1), comprising a pad member (9A) provided with a recess (22), an electrical device (24) received in the recess, and an engagement member (30) that engages with the electrical device inside the recess, wherein the recess is defined by a bottom wall (22B) and an upright wall (22S) extending from the bottom wall, and the engagement member is fixed to the pad member at a position closer to an opening of the recess than the bottom wall, the engagement member being more rigid than the pad member.

According to this aspect, the electrical device is coupled to the pad member via the engagement member. Since the engagement member is more rigid and less likely to deform than the pad member, a vehicle seat can be provided that can retain the electrical device in a more stable manner than in a case where the electrical device is supported by the pad member directly contacting the electrical device.

In the above aspect, preferably, the seat further includes a covering member (42) covering a front side of the electrical device, the recess opens toward a front side of the pad member, and the covering member is housed inside the recess, so that a surface of the covering member is flush with a surface of a peripheral part of the recess of the pad member.

In this aspect, a step is prevented from being created between the surface of the peripheral part of the recess of the pad member and the surface of the covering member. This prevents the seat occupant from experiencing discomfort from the peripheral part of the recess of the pad member.

In the above aspect, preferably, the engagement member is provided with a locking claw that resiliently engages with a side of the electrical device.

In this aspect, the electrical device can be engaged with the engagement member with a simple configuration.

In the above aspect, preferably, the electrical device is provided with a locking recess (37A) that receives the locking claw.

According to this aspect, the engagement member and the electrical device can be engaged firmly.

In the above aspect, preferably, the engagement member includes an engagement member main body (31) that supports the locking claw, the engagement member main body being shaped like a frame into which the electrical device is received, and at least a part of the engagement member main body is provided with a cutout (40).

According to this aspect, the engagement member is easily deformed so that assembling of the electrical device to the engagement member can be facilitated.

In the above aspect, preferably, the engagement member main body is formed as a rectangular frame structure having four corner portions (33), and the cutout is provided at one of the corner portions.

According to this aspect, the engagement member is easily deformed.

In the above aspect, preferably, the locking claw is provided at a position adjacent to one of the cutouts.

According to this aspect, the engagement member is more easily deformed than when the locking claw is provided at a position away from the cutout.

In the above aspect, preferably, the engagement member is insert molded in the pad member.

According to this aspect, the engagement member can be attached to the pad member.

To accomplish such an object, another aspect of the present invention provides a seat pad (9) for forming a vehicle seat (1) fitted with an electrical device (24), comprising: a pad member (9A) having a recess (22) into which the electrical device is to be inserted; and an engagement member (30) attached to a wall surface defining the recess to engage the electrical device, wherein the recess is defined by a bottom wall (22B) and an upright wall (22S) extending upright from the bottom wall, and the engagement member is fixed to a part of the pad member nearer to an opening of the recess that to the bottom wall, the engagement member being more rigid than the pad member.

According to this aspect, the electrical device is connected to the pad member via the engagement member. Since the engagement member is more rigid than the pad member and is less likely to deform, a seat pad can be provided that can hold the electrical device in a more stable manner than when the pad member is in direct contact with the electrical device.

To accomplish such an object, yet another aspect of the present invention provides a manufacturing method for a vehicle seat (1), comprising the steps of molding a pad member such that an engagement member (30) configured to engage an electrical device (24) is attached to a wall surface defining a recess (22) formed in the pad member (9A); inserting the electrical device into the recess to secure the electrical device to the pad member; covering the electrical device with a covering member (42); attaching the pad member to a frame structure (8); and covering a surface of the pad member and a surface of the covering member with a skin material (10), the engagement member having higher rigidity than the pad member.

According to this aspect, the electrical device is attached to the pad member via the engagement member. Since the engagement member is more rigid and less prone to deformation than the pad member, this manufacturing method for a vehicle seat can secure the electrical device in a more stable manner than when the electrical device is supported by the pad member that directly contacts the electrical device.

To solve the above problem, the present invention provides a vehicle seat (101) comprising a frame structure (111), a pad (112) supported by the frame structure, at least one vibration device (107) positioned on a front side of the pad, and at least one air cell (108) positioned on the front side of the pad, the air cell and the vibration device overlapping each other when viewed from a thickness direction of the pad.

According to this aspect, the vibration devices and the air cells can be arranged so as to be densely packed together when viewed from the thickness direction of the pad. Therefore, the air cells and the vibration devices can be favorably arranged on the surface of the pad.

In the above aspect, the pad has at least one first recess (141) recessed from a front surface of the pad to the rear side to receive the vibration device therein, and the air cell is positioned closer to the front side of the pad than the vibration device.

According to this aspect, the vibration device is unlikely to come into contact with the occupant, and discomfort to the occupant is minimized.

In the above aspect, preferably the air cell is fixed to the pad via a fixing member (143).

According to this aspect, the air cell can be fixed to the pad.

In the above aspect, preferably, the at least one air cell includes a pair of air cells positioned spaced apart from each other, a spacer (144) is positioned between the two air cells, and the vibration device overlaps the spacer and the two vibration devices when viewed in a thickness direction of the pad.

According to this aspect, since the spacer fills the space between the two air cells, the vibration of the vibration device is efficiently transmitted to the occupant.

In the above aspect, preferably, each air cell is configured to be inflated by supplying fluid thereto and contracted by discharging fluid therefrom, and the spacer has a surface that is flush with a surface of the air cells in a contracted state.

According to this aspect, steps that may be created between the spacer and the air cells are minimized. Therefore, discomfort to the occupant can be further reduced.

In the above aspect, preferably, the vehicle seat further includes an air blower (109) provide with an air blower which includes an air blower main body (131) and a duct (132) connected to the air blower main body, wherein the pad further includes a ventilation hole (134) passed through the pad in a thickness direction thereof and communicated with the duct, and a ventilation groove (135) connected to the ventilation hole, recessed from a surface of the pad toward a back side thereof, and extending along the surface of the pad, and the at least one first recess is communicated with the ventilation groove.

According to this aspect, the vibration device and the ventilation groove can be arranged so as to be closely packed together when viewed from the thickness direction of the pad. Therefore, in addition to the air cell and the vibration device, the ventilation groove can also be arranged on the surface of the pad in a favorable manner.

In the above aspect, preferably, a width of the ventilation groove is smaller than a width of the first recess.

According to this aspect, when the vibration device is housed in the first recess, the vibration device blocks a part of the opening of the ventilation groove. Therefore, air passing through the ventilation groove is prevented from leaking out of the first recess.

In the above aspect, preferably, a cover pad (146) is placed on the front side of the pad so as to cover the ventilation groove, and is provided with a plurality of through holes (148) that overlap the ventilation groove when viewed from the thickness direction of the pad.

According to this aspect, the cover pad cooperates with the pad to form a flow passage for air forwarded from the blower main body.

In the above aspect, preferably, the cover pad is provided with a plurality of second recesses (151) recessed from a rear surface of the cover pad toward a front surface thereof, and the two air cells are received in the second recesses (151).

According to this aspect, each air cell is prevented from moving in a direction parallel to the surface of the pad.

To accomplish such an object, yet another aspect of the present invention provides a method for manufacturing a vehicle seat (101) including a frame structure (111), a pad (112) supported by the frame structure, at least one vibration device (107) positioned on a front side of the pad, a pair of air cells (108) arranged on the front side of the pad at a distance from each other, a spacer (144) positioned between the two air cells, and a fixing member (143) for fixing the two air cells to the pad, the pad having at least one first recess (141) recessed from the front surface of the pad toward the back side, the method comprising a first step of receiving the vibration device in the first recess; a second step of placing the fixing member on the front side of the pad; a third step of fixing the two air cells to the fixing member so as to overlap with the vibration device when viewed from a thickness direction of the pad; and a fourth step of placing the spacer between the two air cells.

To accomplish such an object, yet another aspect of the present invention provides a vehicle (201) having a vehicle control device (226) that switches a driving mode between an automatic driving mode and a manual driving mode, a first seat (22A) that serves as a driver's seat and is equipped with a plurality of vibration devices (220), and a seat control device (225) that controls the vibration devices, wherein the seat control device executes a notification control to vibrate the vibration devices in order from those located in rear to those located in front when the vehicle control device executes an automatic driving end control to switch the driving mode from the automatic driving mode to the manual driving mode.

According to this aspect, the vibration devices vibrate in order from those located in rear to those located in front so that the occupant is alerted to look ahead in a reliable manner. As a result, in the vehicle, the mode of vibration of the first seat can make the occupant accurately aware of the switch in driving mode.

In the above aspect, preferably, the first seat may be provided on a floor (204) of the vehicle via a rotation device (211) which supports the first seat so as to be rotatable around a vertically extending rotational axis relative to the floor, and the seat control device is configured to determine front-rear positions of the vibration devices base by taking into account the rotational angle of the first seat around the rotational axis.

According to this aspect, even if the seat is rotated by the rotation device, the front-rear positions of each vibration device can be determined in a reliable manner.

In the above aspect, preferably, the first seat is provided with a seat cushion (205) and a seat back (206) extending upward from a rear part of the seat cushion, and the plurality of vibration devices are provided on the seat cushion and the seat back.

According to this aspect, the distance between the frontmost vibration device and the rearmost vibration device can be increased so that the moving distance of the vibrating position can be increased.

In the above aspect, preferably, the seat control device is configured to drive the rotation device so that the first seat faces forward when the first seat faces backward and the vehicle control device executes the automatic driving end control.

According to this aspect, when switching from the automatic driving mode to the manual driving mode, the first seat is caused to face forward so that the occupant can prepare for manual driving.

In the above aspect, preferably, an input device (253) for receiving manual driving operations is provided, and the seat control device is configured to stop vibration of the vibration devices when a predetermined input operation is applied to the input device during execution of the notification control.

According to this aspect, it is possible to estimate that the occupant is ready for the manual driving mode based on the input to the input device by the occupant. Furthermore, when the occupant is ready for the manual driving mode, unnecessary energy consumption can be avoided by stopping vibration of the vibration device.

In the above aspect, preferably, the vehicle control device is configured to defer the manual driving mode from starting while the vibration devices are vibrating due to the notification control, and start the manual driving mode after the vibration devices have stopped vibrating.

According to this aspect, the driving mode is switched from the automatic driving mode to the manual driving mode only after the occupant has completed preparation for the manual driving mode so that the safety of the vehicle is enhanced.

In the above aspect, preferably, the vehicle is provided with a second seat (202B) fitted with another vibration device, and the seat control device is configured to activate the other vibration device of the second seat when the vibration of the vibration devices of the first device has persisted for a predetermined time in the notification control.

According to this aspect, when the occupant seated in the first seat does not respond to the switching of the driving mode, a notification can be given to the occupant seated in the second seat.

In the above aspect, preferably, the vehicle further comprises a voice control device (227) that controls a speaker (255) based on voice information, and the seat control device is configured to execute an additional control so as to control the vibration devices based on the voice information and reduce the amplitude of the vibration of the vibration devices by the additional control when the notification control is executed as compared to when the notification control is not executed.

In this aspect, when the driving mode is switched, the amplitude by the additional control is suppressed, making it easier for the occupant to recognize the vibration by the notification control.

In the above aspect, preferably, the vehicle is provided with an obstacle sensor (251) that detects obstacles around the vehicle, the seat control device is configured to execute an obstacle control to control the vibration devices depending on a position of an obstacle, and the seat control device is configured to prohibit the obstacle control when the notification control is being executed.

According to this aspect, when the driving mode is switched, the obstacle control is prohibited, making it easier for the occupant to recognize the vibration caused by the notification control.

In the above aspect, preferably, the vibration devices include an eccentric rotating mass vibration motor and a linear resonant actuator.

In the above aspect, the occupant can distinguish the notification depending on if the vibration is caused by the eccentric rotating mass vibration motor or the linear resonant actuator.

In the above aspect, preferably, the seat control device is configured to execute a preliminary control for vibrating the vibration devices at an amplitude smaller than the amplitude of the vibration devices in the notification control before executing the notification control.

According to this aspect, the occupant can recognize that the driving mode has been switched from the vibration based on the preliminary control.

In the above aspect, preferably, the seat back is supported so as to be tiltable relative to the seat cushion, and the seat control device increases an amplitude of an output of the vibration devices in the notification control when a reclining angle of the seat back with respect to a vertical plane is equal to or greater than a predetermined first determination value as compared to when the reclining angle is less than the first determination value.

According to this aspect, a larger vibration can be applied to the occupant who may be asleep so that the occupant may be made aware of the change in driving mode.

In the above aspect, preferably, the seat cushion is provided with a load sensor that measures a load received from the occupant, and the seat control device is configured to, in the notification control, increase an amplitude of the vibration devices when the load measured by the load sensor is equal to or greater than a predetermined second determination value as compared to when the load measured by the load sensor is less than the second determination value.

According to this aspect, a larger vibration can be applied to the occupant who is of a larger build.

### BRIEF DESCRIPTION OF THE DRAWING

FIG. 1 A perspective view of a seat according to a first embodiment of the present invention

FIG. 2 A perspective view showing a seat cushion frame structure of the first embodiment

FIG. 3 (A) A top view of the seat pad, (B) A sectional view of the seat cushion taken along line IIIB-IIIB in FIG. 3(A), (C) A side view of an engagement member, and (D) A top view showing a modified example of the engagement member

FIG. 4 A bottom view of the seat cushion frame structure, electrical device, and wire harness

FIG. 5 (A) A bottom view of the first retaining portion of the first embodiment, (B) A sectional view taken along line VB-VB in FIG. 5(A), (C) A sectional view taken along line VC-VC of FIG. 5(A), and (D) A bottom view of the second retaining portion

FIG. 6 A modification of the retaining structure of the first embodiment

FIG. 7 (A) A bottom view of the first retaining portion, (B) A bottom view of the second retaining portion, and (C) A sectional view taken along line VIIC-VIIC of FIG. 7(A), in a second embodiment of the present invention

FIG. 8 (A) A bottom view of the first retaining portion, (B) A bottom view of the second retaining portion, and (C) A sectional view taken along line VIIIC-VIIC of FIG. 8(A), in a third embodiment of the present invention

FIG. 9 (A) A bottom view of the first retaining portion, (B) A bottom view of the second retaining portion, and (C) A sectional view taken along line VIIIC-VIIC of FIG. 9(A), in a fourth embodiment of the present invention

FIG. 10 (A) A bottom view of the first retaining portion, (B) A sectional view taken along line XB-XB of FIG. 10(A), (C) A bottom view of the second retaining portion, and (D) A perspective view of the first retaining portion, in a fifth embodiment of the present invention

FIG. 11 A sectional view of the seat cushion according to a sixth embodiment of the present invention

FIG. 12 A bottom view of the seat cushion frame structure, electrical device, and wire harness to illustrate a modified retaining structure

FIG. 13 A perspective view of the seat according to a seventh embodiment of the present invention

FIG. 14 A front view of the seat back frame structure

FIG. 15 A sectional view showing the main parts of the seat back

FIG. 16 A sectional view showing the main parts of the seat back

FIG. 17 A front view of the seat back pad

FIG. 18 A front view showing the main parts of the seat back

FIG. 19 A sectional view showing the main parts of a mod ified seat back

FIG. 20 An explanatory diagram of the vehicle according to an eighth embodiment of the present invention

FIG. 21 A perspective view of the seat of the eighth embodiment

FIG. 22 An explanatory diagram of the vehicle's control system

FIG. 23 A flow diagram of the notification control executed by the seat control device

### DESCRIPTION OF THE PREFERRED EMBODIMENT(S)

A vehicle seat according to an embodiment of the present invention as applied to a driver's seat and an assistant's seat of an automobile will be described in the following with reference to the appended drawings.

### First Embodiment

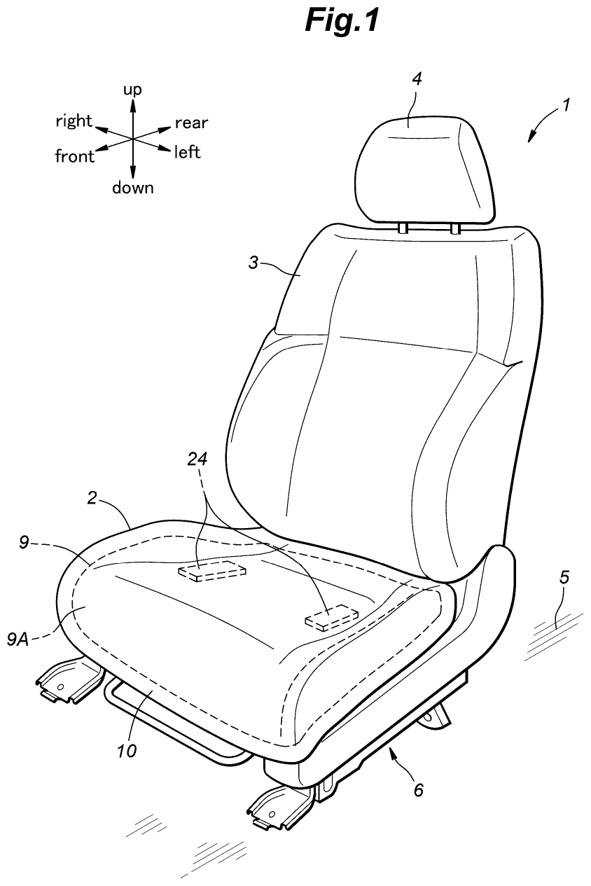

As shown in FIG. 1, the vehicle seat 1 includes a seat cushion 2, a seat back 3, and a headrest 4. The seat cushion 2 may be supported by a pair of slide rails 6 fixed to the floor 5 of a vehicle cabin on either side so that the seat cushion 2 can be slid back and forth.

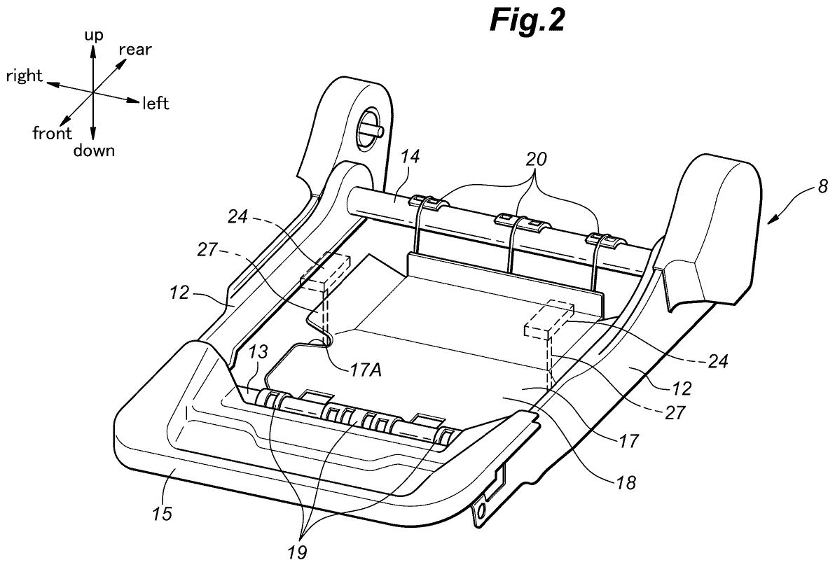

As shown in FIGS. 1 and 2, the seat cushion 2 includes a seat cushion frame structure 8 that forms a skeletal structure of the seat cushion 2, a seat pad 9 supported by the seat cushion frame structure 8, and a skin material 10 that covers at least a part of the seat pad 9.

As shown in FIG. 2, the seat cushion frame structure 8 includes a pair of side members 12 that extend forward and backward on either side, a front member 13 extending laterally between front parts of the left and right side members 12, and a rear member 14 extending laterally between rear parts of the left and right side members 12. In this embodiment, the seat cushion frame structure 8 further includes a front edge member 15 that is connected between the upper front edges of the left and right side members 12. The front edge member 15 is made of a stamp formed sheet metal member, and the upper surface thereof has a shape that generally defines the front part of the seat surface.

A support member 17 extending in the fore and aft direction is spanned between the front member 13 and the rear member 14. The support member 17 includes a plate-shaped support member main body 18 (main body portion) that extends in a substantially horizontal direction along the seat cushion frame structure 8 (specifically, the left and right side members 12), a front attachment portion 19 that extends forward from the front edge of the support member main body 18 and engages with the front member 13, and a rear attachment portion 20 that extends rearward from the rear edge of the support member main body 18 and engages with the rear member 14. The support member 17 may be formed, for example, of a plastic material having metal wires insert molded therein. A pad member 9A is placed on the upper surface of the support member 17, and a skin material 10 is placed on the upper surface of the pad member 9A. When an occupant sits on the seat, the support member 17 bends under the load of the occupant and elastically supports the occupant.

The pad member 9A of the seat pad 9 provides a cushioning action to the seat cushion 2. The pad member 9A is made of a flexible material such as a foamed resin material (e.g., urethane foam). The pad member 9A may be formed, for example, by foaming and hardening a foamed resin material in a cavity (space) defined by an upper mold and a lower mold. The skin material 10 is a cloth member and covers at least a part of the pad member 9A.

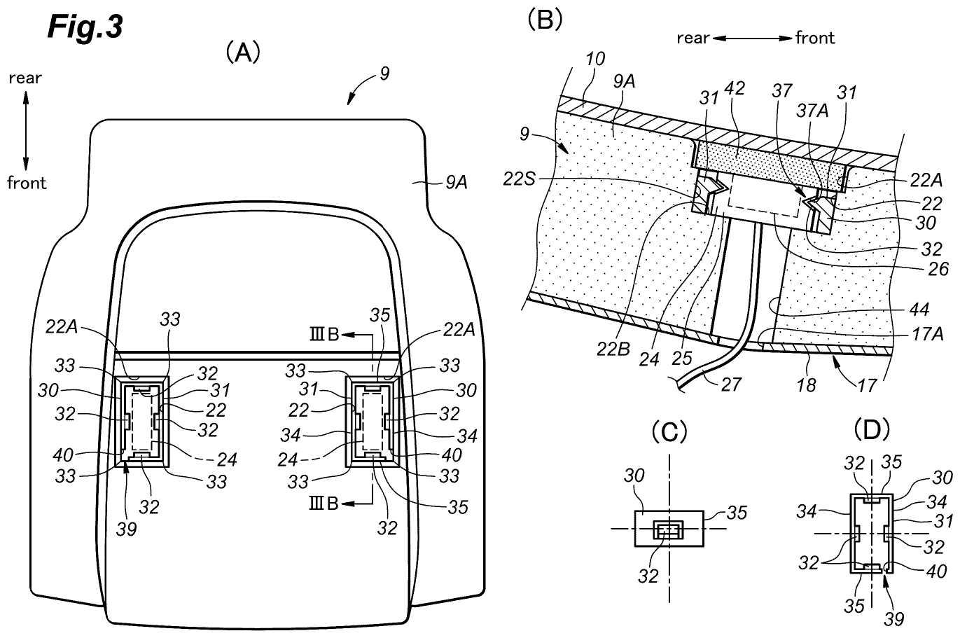

As shown in FIGS. 2 and 3(A), a pad member recess 22 recessed downward is formed on each of the left and right side portions of the pad member 9A. As shown in FIG. 3(B), each pad member recess 22 is recessed from the front surface toward the back surface of the pad member 9A. Each pad member recess 22 is defined by a bottom wall 22B that defines the boundary on the back side (opposite side of the opening) of the pad member recess 22 and an upright wall 22S (also called a peripheral wall) that extends upright from the bottom wall 22B toward the opening of the pad member recess 22. A vibration generating device 24 is placed inside each pad member recess 22.

Each vibration generating device 24 represents one of the electrical devices mounted on the vehicle, and consists of an electric/electronic device for generating vibration. The vibration generating devices 24 are used, for example, to give a notification to the seat occupant by generating vibration. In this embodiment, each vibration generating device 24 includes a device main body 25 and a movable part 26 supported by the device main body 25 in a movable manner, and may consist of a device in which the movable part 26 reciprocates along a prescribed direction relative to the device main body 25 such as a voice coil motor. However, the configuration of each vibration generating device 24 is not limited to this embodiment, and may be configured by an eccentric motor or the like. A wire harness 27 for supplying power and signals is connected to each vibration generating device 24.

In this embodiment, each vibration generating device 24 has a rectangular shape, and is configured so that strong vibration is generated on one of the faces thereof. The wire harness 27 consists of a bendable wire member, and includes one or more electric wires 27A for supplying power to the vibration generating devices 24 and transmitting signals. In this embodiment, the wire harness 27 includes a pair of electric wires 27A and a sheath 27B made of a resin insulator. However, the present invention is not limited to this form, and the wire harness 27 may take any other form as long as it is a member that extends in a linear shape.

In the present invention, since each vibration generating device 24 has a rectangular shape, the corresponding pad member recess 22 has a rectangular shape corresponding to the shape of the corresponding vibration generating device 24. In this embodiment, each vibration generating device 24 is placed in the corresponding pad member recess 22 so that the surface that generates strong vibrations faces upward (i.e., so that the movable part 26 reciprocates in a front to back direction). As a result, each vibration generating device 24 mainly generates vibrations in the front and back direction of the seat cushion 2 (i.e., approximately in the vertical direction).

As shown in FIGS. 3(A) and 3(B), the seat pad 9 includes, in addition to the pad member 9A, a pair of engagement members 30 for connecting the vibration generating device 24 to the pad member 9A. Each engagement member 30 supports the corresponding vibration generating device 24 on the pad member 9A by engaging with the vibration generating device 24, and the vibration generating device 24 is thus connected to the pad member 9A via the engagement member 30. As shown in FIG. 3(A), the pad member recesses 22 are provided symmetrically on the right and left side parts of the seat cushion 2, and the engagement members 30 are placed inside the left and right pad member recesses 22, respectively in a correspondingly symmetrically manner. Each engagement member 30 includes an engagement member main body 31 and at least one locking claw 32 provided on the engagement member main body 31.

As shown in FIG. 3(A), each engagement member main body 31 is in the form of a frame structure having a shape that matches the vibration generating device 24. In this embodiment, the engagement member main body 31 is in the form of a square frame structure having four corner portions 33. More specifically, the engagement member main body 31 is in the form of a rectangular frame structure, and includes a pair of longitudinal portions 34 having mutually opposing surfaces, and a pair of lateral portions 35 having mutually opposing surfaces. The longitudinal portions 34 are each in the form of a plate extending along the longitudinal direction of the engagement member main body 31. The lateral portions 35 are each in the form of a plate extending along the lateral direction of the engagement member main body 31. The longitudinal portions 34 and the lateral portions 35 are connected to each other via the corner portions 33.

The locking claws 32 are provided on the mutually opposing surfaces of the longitudinal portions 34 and on the mutually opposing surfaces of the lateral portions 35. The locking claws 32 provided on the longitudinal portions 34 protrude toward each other, and the locking claws 32 provided on the lateral portions 35 protrude toward each other. Preferably, each locking claw 32 is configured to be elastically deformable with respect to the engagement member main body 31.

The engagement members 30 have a higher rigidity than the pad member 9A. The engagement members 30 may be made of a resin material such as polyethylene. The engagement members 30 may be made harder than the pad member 9A by reducing the foaming ratio thereof. Since the engagement members 30 have a higher rigidity than the pad member 9A, the engagement members 30 are less likely to deform than the pad member 9A under the load applied thereto when an occupant sits on the vehicle seat 1.

Each engagement member 30 is fixed to a part of the pad member 9A located inside the pad member recess 22 which is closer to the opening side of the pad member recess 22 than the bottom wall 22B. Each engagement member 30 may be positioned inside or outside of the upright wall 22S. However, from the view point of ease of assembly of the vibration generating device 24, it is preferable that at least a part of the engagement member 30 is exposed inside the pad member recess 22. For example, the engagement member 30 may be fixed to the upright wall 22S at the outer surface of the engagement member main body 31. The engagement member 30 may be insert molded into the pad member 9A, and the engagement member 30 may be fixed to the wall surface that defines the pad member recess 22 of the pad member 9A. More specifically, when the foamed resin material is foamed and cured in the cavity to form the pad member 9A, the engagement member 30 may be positioned so that at least a part of the engagement member 30 (in this embodiment, the outer surface of the engagement member main body 31) is exposed in the cavity when the foamed resin material is foamed and cured to form the pad member 9A. However, the present invention is not limited to this embodiment, and the engagement member 30 may be bonded, for example, by an adhesive or the like to the wall surface that defines the pad member recess 22 on the outer surface of the engagement member main body 31.

As shown in FIG. 3 (B), when the vibration generating device 24 is inserted into the interior of the engagement member main body 31, the locking claws 32 resiliently engage with the side of the electrical device so that the vibration generating device 24 is locked to the engagement member 30. As a result, the vibration generating device 24 is supported by the pad member 9A via the engagement member 30.

In this embodiment, the vibration generating device 24 is provided with a pair of locking portions 37 on either lateral side thereof that are configured to engage with the locking claws 32. Each locking portion 37 is formed as a locking recess 37A that is recessed inward on the side surface of the vibration generating device 24. The tip of each locking claw 32 enters the corresponding locking portion 37 of the vibration generating device 24 so that the vibration generating device 24 is firmly attached to the engagement member 30 than when the locking portions 37 are not provided.

When the vibration generating device 24 is inserted into the interior of the engagement member main body 31, the locking claws 32 resiliently engage with the side surfaces of the vibration generating device 24 so that the vibration generating device 24 is assembled to the engagement member 30. In order to facilitate the assembly of the vibration generating device 24 to the engagement member 30, it is preferable that the engagement member main body 31 is provided with an easily deformable portion 39 for facilitating the deformation of the engagement member main body 31 during assembly.

In this embodiment, as shown in FIG. 3(A), the easily deformable portion 39 is configured as a cutout 40 provided at one corner portion 33 of the engagement member main body 31. The cutout 40 is a slit-like portion formed at the corner portion 33, and separates the longitudinal portion 34 and the lateral portion 35 from each other. This causes the engagement member main body 31 to be approximately C-shaped. In this embodiment, the two engagement members 30 are positioned inside the corresponding pad member recesses 22 and secured the pad member 9A so that the cutouts 40 are located on either laterally outer side of the seat.

However, the cutout 40 of the present invention is not limited to the one that separates the longitudinal portion 34 and the lateral portion 35 from each other, and may also be a notch which cuts into the engagement member main body 31 to such an extent as not to separate the longitudinal portion 34 and the lateral portion 35 from each other, or a thin-walled portion provided in the longitudinal portion 34 or the lateral portion 35 so as to be thinner than the remaining part of the engagement member main body 31, instead of a cutout 40.

As shown in FIG. 3(C), the locking claw 32 are provided each at a substantially central position of the inner peripheral surface of the longitudinal portion 34 or the lateral portion 35. However, the present invention is not limited to this embodiment, and the locking claw 32 provided on the longitudinal portion 34 or the lateral portion 35 adjacent to the corner portion 33 where the cutout 40 is formed may be provided at a position offset toward the cutout 40.

In FIG. 3(A), the cutout 40 is provided at one of the corner portions 33, but as shown in FIG. 3(D), the cutout 40 may be provided at a position adjacent to the locking claw 32 of one of the longitudinal portions 34 and the lateral portions 35. In this way, by providing the locking claw 32 adjacent to the cutout 40, the part where the locking claw 32 is formed may be made more easily deformable than when the locking claw 32 is provided at a position away from the cutout 40. This facilitates the insertion of the vibration generating device 24 into the engagement member main body 31, and facilitates the assembling of the vibration generating device 24 to the engagement member 30.

As shown in FIG. 3(B), the seat pad 9 includes a covering member 42 (also called a cushioning material or slab) provided on the upper surface (front side) of each vibration generating device 24. The covering member 42 reduces the discomfort to the occupant that may be caused by the vibration generating device 24 being provided on the pad member 9A by serving as a cushioning material that reduces the vibration generated by the vibration generating device 24 from becoming excessive. The covering member 42 is preferably made of a material that is more flexible than the pad member 9A. It may also be made of a material that is less flexible than the pad member 9A.

The covering member 42 is placed inside the pad member recess 22 on top of (front side) the vibration generating device 24. In this embodiment, an enlarged portion 22A is provided at the upper end of the pad member recess 22 such that the open end of the pad member recess 22 is wider than the remaining part of the pad member recess 22, and the covering member 42 is received in the enlarged portion 22A. The engagement member 30 is fixed to the wall surface of the part of pad member recess 22 located under (on the back side) the enlarged portion 22A. Thus, the vibration generating device 24 is fixed to the upper part of the pad member recess 22 via the engagement member 30, and the upper surface (front surface) thereof is covered by the covering member 42.

The surface of the covering members 42 is flush with the surface of the part of the pad member 9A surrounding pad member recesses 22. This makes it possible to prevent steps from being created between the surface of the surrounding part of the pad member recesses 22 of the pad member 9A and the surface of the covering members 42. This reduces the discomfort which the seated person may experience from the surrounding part of the pad member recesses 22 of the pad member 9A. The skin material 10 covers the surface of the pad member 9A and the surface of the covering member 42.

The pad member 9A is provided with a through hole 44 that extends downward (toward the back side) from the bottom surface of each pad member recess 22 and reaches the lower surface (back surface) of the pad member 9A. The through hole 44 extends from the bottom surface of the pad member recess 22 to the back surface of the pad member 9A, and defines a passage for passing the wire harness 27 therethrough. The wire harness 27 passes through the through hole 44 from the vibration generating device 24 and reaches the back surface of the pad member 9A.

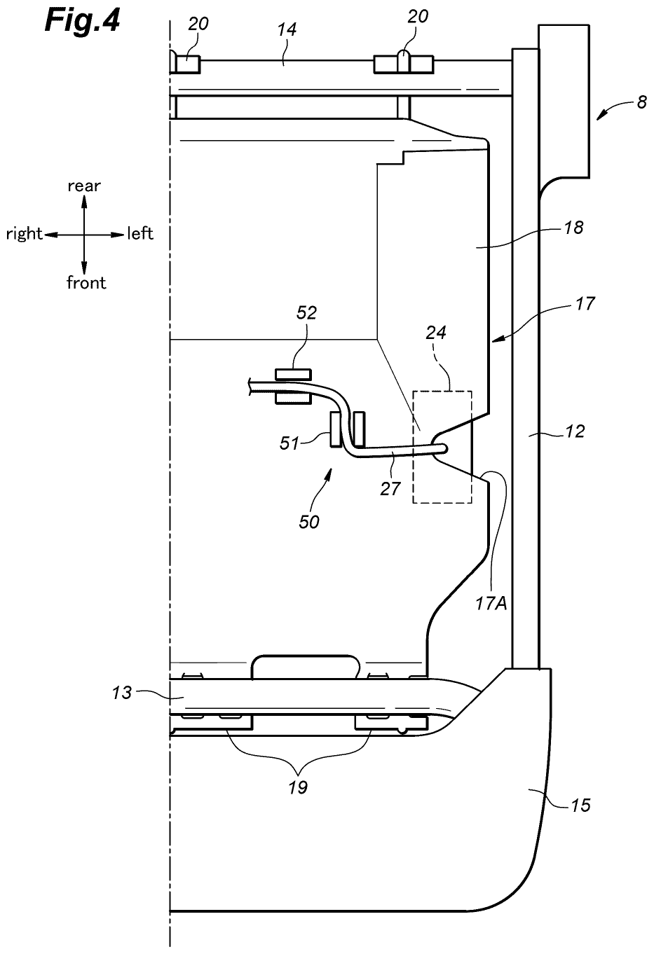

As shown in FIG. 4, each vibration generating device 24 overlaps with the peripheral edge part of the support member 17 when viewed from above. The support member 17 is formed with a notch 17A on each laterally outer edge thereof, which is cut inward of the seat. The wire harness 27 passes through the through hole 44 and extends downward, passes through the notch 17A and extends inward of the seat, and reaches the back surface (lower surface) of the support member 17.

A retaining structure 50 is provided on the back surface (lower surface) of the support member 17 to allow the support member 17 to retain the wire harness 27. The retaining structure 50 is integrally molded with the support member main body 18. The retaining structure 50 serves to prevent the wire harness 27 from being detached from the support member 17 and to secure the wire harness 27 to the support member 17 while allowing the wire harness 27 to move in the lengthwise direction thereof. The wire harness 27 is attached to the back surface of the support member 17 by the retaining structure 50 and is retained by the support member 17. Preferably, the support member 17 is provided with a retaining structure 50 for each wire harness 27.

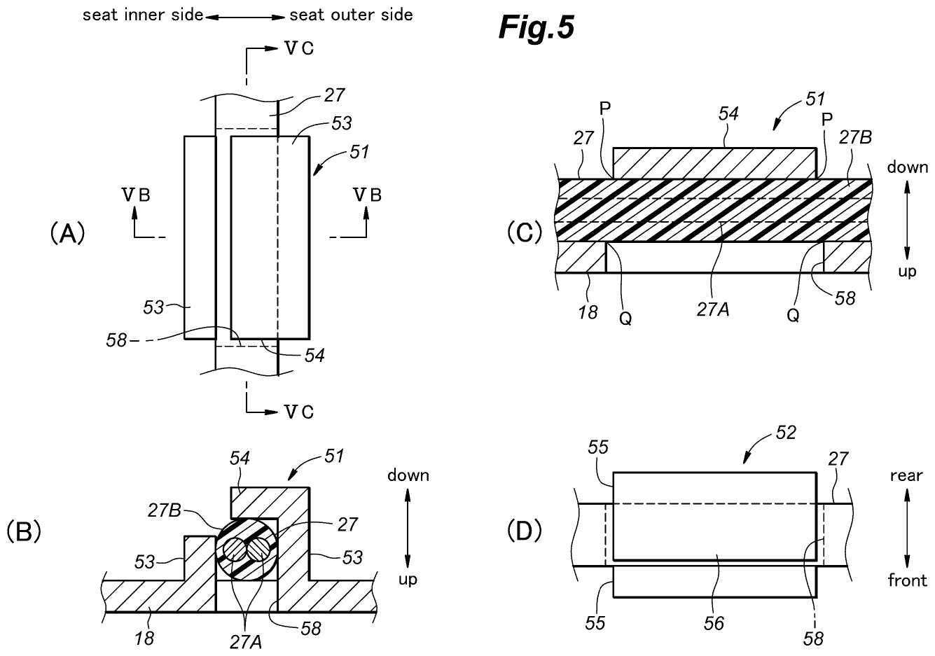

As shown in FIG. 4, each retaining structure 50 includes a first retaining portion 51 and a second retaining portion 52. The first retaining portion 51 and the second retaining portion 52 are both integrally molded with the support member main body 18. It should be noted that FIG. 4 only generally shows the positions and structure of the first retaining portion 51 and the second retaining portion 52, and FIGS. 5(A) to (D) show the structure of the first retaining portion 51 and the second retaining portion 52 in greater detail.

As shown in FIGS. 5(A) and 5(B), the first retaining portion 51 includes a pair of first base portions 53 aligned with each other in the lateral direction. As shown in FIG. 5(B), the first base portions 53 each protrude downward from the back surface of the support member 17. In this embodiment, the first base portions 53 each have a plate shape facing laterally.

The wire harness 27 passes between the two first base portions 53. As a result, the first retaining portion 51 holds the wire harness 27 in such a manner that the wire harness 27 can move in the fore and aft direction while being prevented from moving in the lateral direction. In other words, the wire harness 27 is secured to the support member main body 18 by the first retaining portion 51 so as to be movable in the fore and aft direction while being prevented from moving laterally.

As shown in FIG. 5(B), at least one of the free ends (lower ends) of the left and right first base portions 53 is provided with a first restricting piece 54 extending toward the other first base portion 53. In this embodiment, as shown in FIG. 5(A), the fore and aft length of the base end portion of the first restricting piece 54 is equal to the fore and aft length of the free end of the first base portion 53, and the first restricting piece 54 protrudes from the entire free end of one of the first base portions 53 toward the free end of the other first base portion 53. As shown in FIGS. 5(B) and 5(C), the first restricting piece 54 restricts the movement of the wire harness 27 away from the support member main body 18 (i.e., downward, or in the direction of the back side). In this embodiment, the first restricting piece 54 is provided at the free end of the first base portion 53 located on the outer side of the seat.

As shown in FIG. 5(B), it is preferable that the distance between the projecting end of the first restricting piece 54 and the tip of the other first base portion 53 is slightly smaller than the diameter of the wire harness 27.

As shown in FIG. 5(D), the second retaining portion 52 includes a pair of second base portions 55 arranged along the fore and aft direction. The second base portions 55 protrude downward from the back surface of the support member 17. In this embodiment, the second base portions 55 each have a plate shape facing approximately in the fore and aft direction.

The wire harness 27 is passed through between the two second base portions 55. As a result, the second retaining portion 52 retains the wire harness 27 so that the wire harness 27 can move in the lateral direction while being restricted from moving in the fore and aft direction. In other words, the wire harness 27 is retained to the support member main body 18 so that it can move in the fore and aft direction while the lateral movement thereof is restricted by the second retaining portion 52.

The free end (lower ends) of at least one of the second base portions 55 is provided with a second restricting piece 56 extending toward the free end of the other second base portion 55. The second restricting piece 56 restricts the movement of the wire harness 27 away from the support member main body 18 (i.e., downward, or in the direction of the back side). In this embodiment, the second restricting piece 56 is provided at the free end of the second base portions 55 located in the rear.

In this embodiment, the support member 17 is manufactured by combining an upper mold and a lower mold. Therefore, in this embodiment, in order to facilitate demolding or die parting, as shown in FIGS. 5(B) and 5(D), a demolding hole 58 (die parting hole 58) is provided at a part of the support member 17 that vertically aligns with the first restricting piece 54 and at a position that vertically aligns with the second restricting piece 56.

As shown in FIG. 5(A), the demolding hole 58 is preferably larger than the first restricting piece 54 (or the second restricting piece 56) in top view. As a result, as shown in FIG. 5(C), the free end P of the first restricting piece 54 and the opposing edge Q of the demolding hole 58 are horizontally offset from each other. By configuring the demolding hole 58 to be larger than the first restricting piece 54 (or the second restricting piece 56) in top view, the manufacturing of the support member 17 is facilitated and the deformability of the support member 17 is increased.

As shown in FIG. 4, the first retaining portion 51 and the second retaining portion 52 are provided at positions spaced apart from each other. The second retaining portion 52 is preferably provided at a position spaced apart from the first retaining portion 51 in the fore and aft direction and the lateral direction. In this embodiment, the second retaining portion 52 is positioned on the inner side of the seat (specifically, on the laterally inner side of the seat) and at a position offset rearward from the first retaining portion 51.

More specifically, the first base portions 53 are both located more on the outer side of the seat as compared to the outer ends of the second base portions 55, and are located laterally closer to the notch 17A than the second base portions 55. Furthermore, the first base portions 53 are located forward of the front end of the second base portions 55, and closer to the notch 17A in the fore and aft direction than the second base portions 55. In this embodiment, the first retaining portion 51 is located laterally inward of the inner end of the notch 17A.

The wire harness 27 extends from the through hole 44 toward the notch 17A, passes through the seat inner end of the notch 17A, and extends inward of the seat. After that, the wire harness 27 passes between the first base portions 53, bends rearward, bends further inward of the seat, passes between the second base portions 55, and extends further inward of the seat. The wire harness 27 is connected to a control device (not shown in the drawings) that controls the operation of the vibration generating device 24. The control device may be attached to the bottom of the seat cushion 2, or may be attached to the vehicle body on which the vehicle seat 1 is mounted.

Next, a method for manufacturing the vehicle seat 1 configured in this manner will be described in the following.

First, the worker who manufactures the vehicle seat 1 places the engagement members 30 in the mold cavity and insert-mold them into the pad member 9A. As a result, the pad member recesses 22 for accommodating the vibration generating devices 24 are formed in the pad member 9A, and the engagement members 30 are secured to the pad member 9A at the same time.

Then, the worker places the pad member 9A to which the engagement members 30 are fixed on the upper side (front side) of the support member 17 supported by the seat cushion frame structure 8. Next, the worker passes the wire harness 27 through the through hole 44, inserts the vibration generating device 24 into the pad member recess 22, and engages the vibration generating device 24 with the engagement member 30. As a result, the vibration generating device 24 is placed in the pad member recess 22 of the pad member 9A, and is secured to the pad member 9A via the engagement member 30. Furthermore, the worker pulls out the wire harness 27 from the lower side of the through hole 44, and secures the wire harness 27 to the first retaining portion 51 and the second retaining portion 52. Thereafter, when the vehicle seat 1 is assembled to the vehicle body, the worker performing the assembly work connects the wire harness 27 to the control device.

Next, the effects of the vehicle seat 1 and the manufacturing method for the vehicle seat 1 configured in this manner will be discussed in the following.

The wire harness 27 extends in the fore and aft direction (first direction) at the first retaining portion 51, and is retained by the engagement member 30 so as to be movable in the lengthwise direction. Also, the wire harness 27 extends laterally (in the second direction) at the second retaining portion 52, and is retained by the engagement member 30 so as to be movable in the lengthwise direction. Therefore, the wire harness 27 is secured to the support member 17 so as to be movable in the lengthwise direction thereof.

When an occupant is seated on the vehicle seat 1, the vibration generating device 24 moves under the load of the seated occupant. Since the wire harness 27 is movable in the lengthwise direction thereof, the wire harness 27 can move in the lengthwise direction so that the wire harness 27 is pulled out as required by the movement of the vibration generating device 24. Thereby, a vehicle seat 1 and a method for manufacturing a vehicle seat 1 are provided in such a manner that the wire harness 27 can be retained on the support member 17 while the load that may be applied to the wire harness 27 can be reduced.

The first retaining portion 51 is provided with a pair of first base portions 53 laterally aligned with each other, and the wire harness 27 is placed between the first base portions 53. Therefore, with a simple configuration, the wire harness 27 can be retained by the first retaining portion 51 so as to extend in the fore and aft direction and be movable in the lengthwise direction thereof.

The second retaining portion 52 is provided with a pair of second base portions 55 arranged one behind the other, and the wire harness 27 is placed between the second base portions 55. Therefore, with a simple configuration, the wire harness 27 can be retained by the second retaining portion 52 so as to extend in the lateral direction and be movable in the lengthwise direction thereof.

The first base portions 53 are each plate-shaped and face in the fore and aft direction. Therefore, it is possible to ensure an adequate contact area facing in the fore and aft direction between the first base portions 53 and the wire harness 27 so that the first retaining portion 51 can effectively restrict the movement of the wire harness 27 in the fore and aft direction. Similarly, the second base portions 55 are each plate-shaped and face in the lateral direction. Therefore, it is possible to ensure a contact area facing in the lateral direction between the second base portions 55 and the wire harness 27 so that the second retaining portion 52 can effectively restrict the movement of the wire harness 27 in the lateral direction.

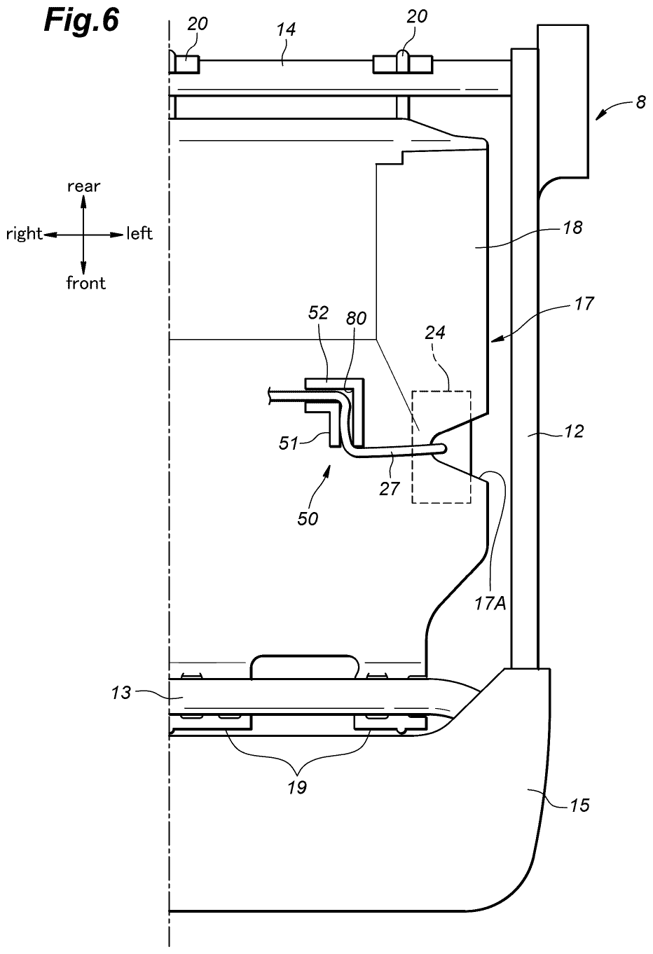

In FIG. 4, the first and second retaining portions 51 and 52 are positioned so as to be spaced apart from each other, but as shown in the modified embodiment of FIG. 6, the first and second retaining portions 51 and 52 may be provided so as to be connected to each other. However, when the first and second retaining portions 51 and 52 are provided at positions spaced apart from each other, the wire harness 27 can be secured to the support member 17 in a more gradually curved manner than when the first and second retaining portions 51 and 52 are connected to each other. In particular, stress is prevented from being concentrated in the part of the wire harness 27 located between the first and second retaining portions 51 and 52.

The second retaining portion 52 is provided at a position offset from the first retaining portion 51 in both the fore and aft direction and the lateral direction (i.e., a position spaced apart in both directions). Therefore, the stress that may be applied to the part of the wire harness 27 located between the first retaining portion 51 and the second retaining portion 52 can be effectively reduced.

As shown in FIG. 5(B), the first restricting piece 54 is provided at the tip end of one of the first base portions 53 located on the outer side of the seat (the laterally outer side of the seat). Therefore, the wire harness 27 can be prevented from moving downward away from the support member 17 at the first retaining portion 51. Similarly, the second restricting piece 56 is also provided at the tip of the rear second base portion 55. Therefore, the wire harness 27 can be prevented from moving downward away from the support member 17 at the second retaining portion 52.

### Second Embodiment

The vehicle seat 1 according to the second embodiment of the present invention differs from that of the first embodiment only in the retaining structure 50, and the configurations of the second embodiment are otherwise similar to those of the first embodiment. Therefore, the description of the configurations other than the retaining structure 50 will be omitted in the following disclosure.

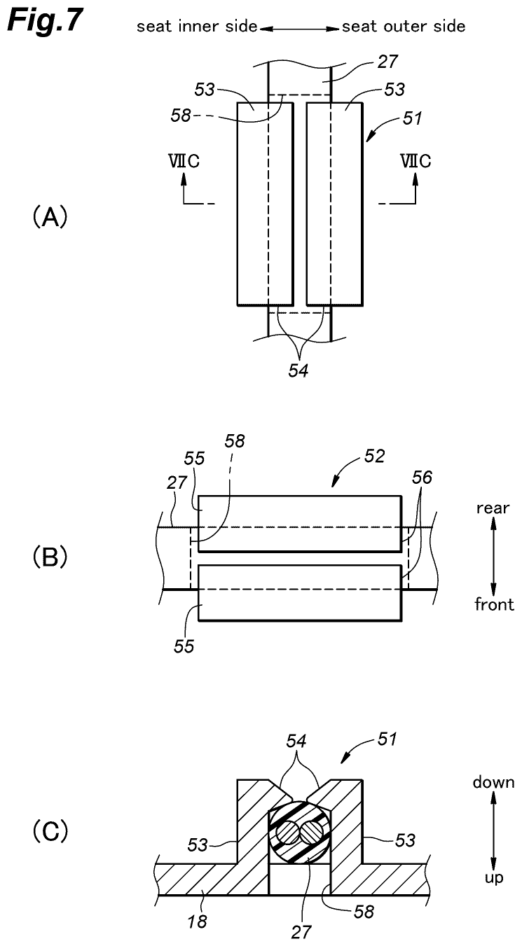

The retaining structure 50 of the second embodiment includes a first retaining portion 51 and a second retaining portion 52 similarly as in the first embodiment. As shown in FIG. 7(A), the first retaining portion 51 secures the wire harness 27 to the support member main body 18 so as to be movable in the fore and aft direction while restricting movement of the wire harness 27 in the lateral direction. As shown in FIG. 7(B), the second retaining portion 52 secures the wire harness 27 to the support member main body 18 so as to be movable in the lateral direction while restricting movement of the wire harness 27 in the fore and aft direction. The first retaining portion 51 and the second retaining portion 52 are provided at positions on the support member main body 18 that are generally similar to those in the first embodiment.

As in the first embodiment, the first retaining portion 51 includes a pair of first base portions 53 on the left and right, and the second retaining portion 52 includes a pair of second base portions 55 on the front and rear. However, in the second embodiment, a first restricting piece 54 is provided on each of the two first base portions 53, and a second restricting piece 56 is provided on each of the two second base portions 55.

Each first restricting piece 54 is connected to the corresponding first base portion 53 at the base end portion thereof and extends horizontally toward the other first base portion 53. As shown in FIG. 7(C), the free end of each first restricting piece 54 is tapered from the base end portion thereof. As a result, each first restricting piece 54 forms a restricting claw having a claw shape. The first restricting piece 54 provided on one of the first base portions 53 and the first restricting piece 54 provided on the other first base portion 53 extend toward each other when viewed in the horizontal direction, and the distance between the two free ends is smaller than the diameter of the wire harness 27 when viewed in the horizontal direction.

Each second restricting piece 56 is connected to the corresponding second base portion 55 at the base end portion thereof and extends horizontally toward the other second base portion 55. Each second restricting piece 56 is tapered and claw-shaped. The second restricting piece 56 provided on one of the second base portion 55 and the second restricting piece 56 provided on the other second base portion 55 extend toward each other when viewed in the horizontal direction, and the distance between the two free ends is smaller than the diameter of the wire harness 27 when viewed in the horizontal direction.

In this embodiment, as in the first embodiment, demolding holes 58 are provided in the support member 17 to facilitate demolding. One of the demolding holes 58 is provided so as to be vertically aligned with the first restricting pieces 54 of the first base portions 53, and the other is provided so as to be vertically aligned with the second restricting pieces 56.

The plate thickness of the first base portions 53 and the second base portions 55 may be smaller than that of the first embodiment. This allows the first base portions 53 to readily undergo bending deformation in the lateral direction, and the second base portions 55 to readily undergo bending deformation in the fore and aft direction.

Next, the effect of the vehicle seat 1 configured in this way will be discussed in the following.

As in the first embodiment, the wire harness 27 extends in the fore and aft direction at the first retaining portion 51 and is retained by the engagement member 30 so as to be movable in the lengthwise direction. Furthermore, the wire harness 27 extends in the second direction at the second retaining portion 52 and is retained by the engagement member 30 so as to be movable in the lengthwise direction. Thus, the wire harness 27 is secured to the support member 17 so as to be movable in the lengthwise direction.

When an occupant is seated on the vehicle seat 1, the vibration generating device 24 moves under the load of the seated occupant. Since the wire harness 27 is movable in the lengthwise direction thereof, the wire harness 27 can move in the lengthwise direction in such a manner that the wire harness 27 is pulled out in response to the movement of the vibration generating device 24. Thereby, a vehicle seat 1 is provided that can retain the wire harness 27 on the support member 17 while reducing the load that may be applied to the wire harness 27.

In the second embodiment, when the wire harness 27 is inserted from below until the wire harness 27 is positioned above the first restricting pieces 54 and the second restricting pieces 56, the wire harness 27 is retained by the support member 17. In this way, the wire harness 27 can be assembled to the support member 17 by inserting the wire harness 27 upward, facilitating the assembling of the wire harness 27.

### Third Embodiment

The vehicle seat 1 according to the third embodiment of the present invention is different from the first embodiment only in the retaining structure 50, and is otherwise similar to that of the first embodiment. Therefore, the description of the configurations other than the retaining structure 50 will be omitted in the following disclosure.

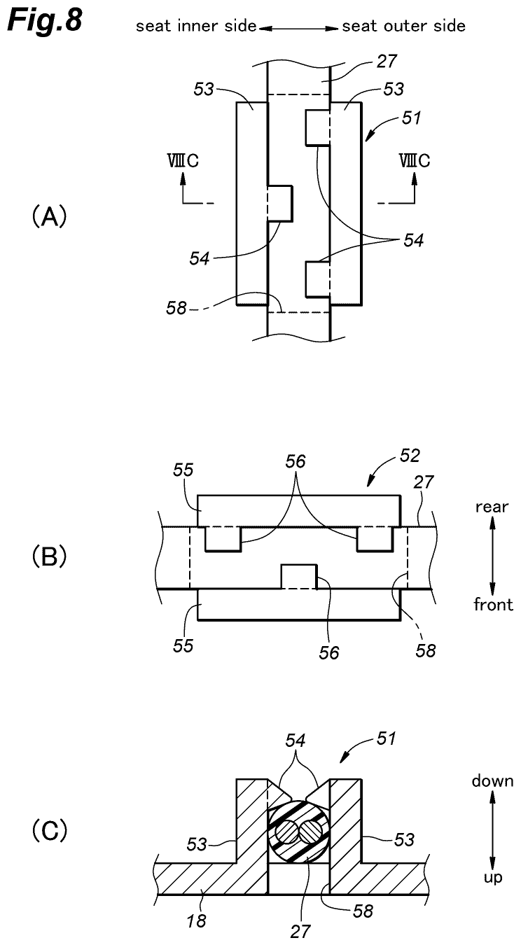

The retaining structure 50 of the third embodiment includes a first retaining portion 51 and a second retaining portion 52, as in the first embodiment. As shown in FIG. 8(A), the first retaining portion 51 secures the wire harness 27 to the support member main body 18 so as to be movable in the fore and aft direction while restricting the movement of the wire harness 27 in the lateral direction. As shown in FIG. 8(B), the second retaining portion 52 secures the wire harness 27 to the support member main body 18 so as to be movable in the lateral direction while restricting the movement of the wire harness 27 in the fore and aft direction. The first retaining portion 51 and the second retaining portion 52 are provided at approximately the same positions as those of the support member main body 18 of the first embodiment.

As shown in FIG. 8(A), the first retaining portion 51 includes a pair of first base portions 53 positioned laterally next to each other, and the second retaining portion 52 includes a pair of second base portions 55 positioned one behind the other, as in the first embodiment. However, in the retaining structure 50 of the third embodiment, the free end of one of the first base portions 53 is provided with a first restricting piece 54 extending toward the other first base portion 53. The free end of the other first base portion 53 is provided with two or more first restricting pieces 54.

The first restricting piece 54 provided on one of first base portion 53 and the first restricting pieces 54 provided on the other first base portion 53 are positioned so as not to overlap when viewed in the lateral direction. In this embodiment, the first restricting piece 54 provided on one of the first base portions 53 and the first restricting pieces 54 provided on the other first base portion 53 are arranged in a staggered or alternating arrangement along the fore and aft direction.

As shown in FIG. 8(B), second restricting pieces 56 are provided at the free ends of the front and rear second base portions 55. The second restricting pieces 56 extend toward the opposing second base portions 55. As with the first restricting pieces 54, the second restricting pieces 56 provided on the second base portions 55 are arranged so as not to overlap one another when viewed in the fore and aft direction. In this embodiment, the second restricting piece 56 provided on one of the second base portion 55 and the second restricting pieces 56 provided on the other second base portion 55 are arranged in a staggered arrangement along the lateral direction.

In this embodiment, as shown in FIG. 8(C), the free ends of the first restricting pieces 54 and the second restricting pieces 56 are tapered into a claw shape, as in the second embodiment. As a result, the first restricting pieces 54 and the second restricting pieces 56 each serve as a restricting claw that restricts the downward movement of the wire harness 27.

The distance between the tips of the first restricting pieces 54 provided on the left and right first base portions 53 is smaller than the diameter of the wire harness 27 when viewed in the fore and aft direction. Similarly, the distance between the tips of the second restricting pieces 56 provided on the front and rear second base portions 55 is smaller than the diameter of the wire harness 27 when viewed in the lateral direction.

Next, the effects of the vehicle seat 1 configured in this manner will be discussed in the following.

As in the first embodiment, the wire harness 27 extends in the fore and aft direction at the first retaining portion 51 and is retained by the engagement member 30 so as to be movable in the lengthwise direction. Furthermore, the wire harness 27 extends in the second direction at the second retaining portion 52 and is retained by the engagement member 30 so as to be movable in the lengthwise direction. Thus, the wire harness 27 is secured to the support member 17 so as to be movable in the lengthwise direction thereof.

When an occupant is seated on the vehicle seat 1, the vibration generating device 24 moves under the load of the seated occupant. Since the wire harness 27 is movable in the lengthwise direction thereof, the wire harness 27 can move in the lengthwise direction in such a manner that the wire harness 27 is pulled out in response to the movement of the vibration generating device 24. Thus, a vehicle seat 1 is provided that can retain the wire harness 27 on the support member 17 while reducing the load that may be applied to the wire harness 27.

In this embodiment, the first restricting pieces 54 and the second restricting pieces 56 are positioned in a staggered relationship. Therefore, the worker can easily insert the wire harness 27 between the two first base portions 53 or between the two second base portions 55 so that the efficiency of assembling the wire harness 27 to the support member 17 can be improved.

### Fourth Embodiment

The vehicle seat 1 according to the fourth embodiment of the present invention differs from the first embodiment only in the retaining structure 50, and is otherwise similar to the first embodiment. Therefore, the description of the configurations other than the retaining structure 50 will be omitted in the following disclosure.

The retaining structure 50 of the fourth embodiment includes a first retaining portion 51 and a second retaining portion 52, as in the first embodiment. The first retaining portion 51 and the second retaining portion 52 are provided at positions on the support member main body 18 that are generally the same as those in the first embodiment.

The first retaining portion 51 and the second retaining portion 52 each include a main part 60 that retains the wire harness 27 and a secondary part 61 that prevents the wire harness 27 from coming off the main part 60.

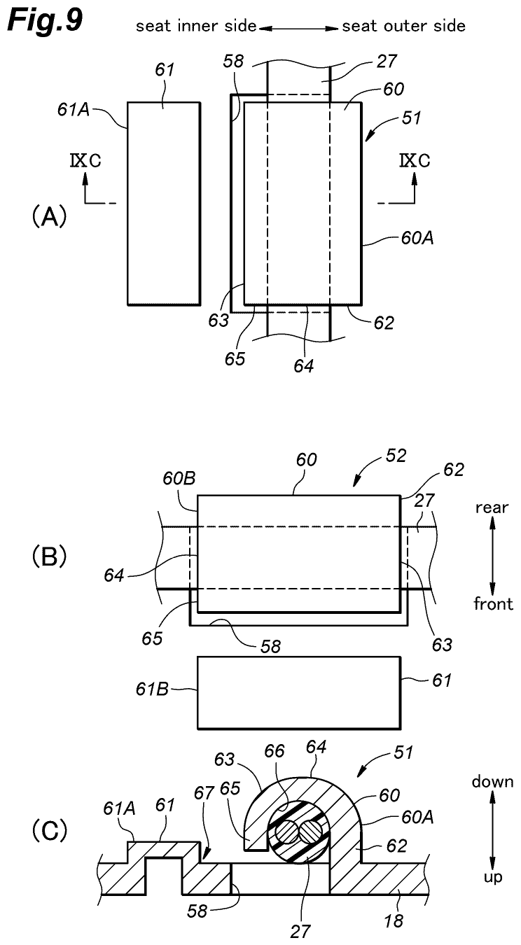

As shown in FIG. 9(A), the main part 60 of the first retaining portion 51 (hereinafter, the first main part 60A) is provided on the outer side of the secondary part 61 of the first retaining portion 51 (hereinafter, the first secondary part 61A) with respect to the seat. As shown in FIG. 9(B), the main part 60 of the second retaining portion 52 (hereinafter, the second main part 60B) is located behind the secondary part 61 of the second retaining portion 52 (hereinafter, the second secondary part 61B).

As shown in FIG. 9(C), the main part 60 includes a plate-shaped portion 62 that extends downward and faces in the horizontal direction and a claw part 63 provided at the free end of the plate-shaped portion 62. The claw part 63 is provided with an extension part 64 that extends horizontally, and a locking portion 65 that protrudes upward from the free end of the extension part 64. As a result, the claw part 63 is formed so as to define a concave shape facing upward at the free end thereof. The plate-shaped portion 62 and the claw part 63 jointly define a receiving recess 66 that is recessed downward and receives the wire harness 27 therein.

In this embodiment, the distance between the plate-shaped portion 62 and the locking portion 65 is selected to coincide with the diameter of the wire harness 27 or to be slightly smaller than the diameter of the wire harness 27. As a result, the wire harness 27 is received in the receiving recess 66 so as to be clamped between the plate-shaped portion 62 and the locking portion 65.

The plate-shaped portion 62 of the first main part 60A is plate-shaped and faces in the lateral direction. The extension part 64 of the first main part 60A extends inward with respect to the seat (more specifically, toward the laterally inner side of the seat). The locking portion 65 of the first main part 60A is located more on the inner side of the seat than the plate-shaped portion 62 of the first main part 60A. The locking portion 65 of the first main part 60A is plate-shaped and faces laterally, similarly to the plate-shaped portion 62 of the first main part 60A. As a result, the wire harness 27 is retained by the first retaining portion 51 so as to be movable in the fore and aft direction and not movable in the lateral direction. In this way, the plate-shaped portion 62 and the locking portion 65 of the first main part 60A function similarly to the first base portions 53 of the first embodiment in restricting the movement of the wire harness 27 in a direction perpendicular to the lengthwise direction (lateral direction) thereof.

The plate-shaped portion 62 of the second main part 60B is plate-shaped and faces in the fore and aft direction. The locking portion 65 of the second main part 60B is also plate-shaped and faces in the fore and aft direction. As a result, the wire harness 27 is retained by the second retaining portion 52 so as to be movable in the fore and aft direction and not movable in the lateral direction. In this way, the plate-shaped portion 62 and the locking portion 65 of the second main part 60B function similarly to the first base portions 53 of the first embodiment in restricting the movement of the wire harness 27 in a direction perpendicular to the lengthwise direction (lateral direction).

The first secondary part 61A extends forward and backward on the inner side of the locking portion 65 of the first main part 60A with respect to the seat. In this embodiment, the first secondary part 61A forms a ridge that bulges downward on the inner side of the locking portion 65 of the first main part 60A with respect to the seat. A step portion 67 is formed at the boundary between the first secondary part 61A and the support member main body 18. The protruding amount of the first secondary part 61A is greater than the vertical distance between the locking portion 65 of the first main part 60A and the support member main body 18 so that the first secondary part 61A blocks the gap between the locking portion 65 of the first main part 60A and the support member main body 18. This prevents the wire harness 27 from coming off the first main part 60A.

The second secondary part 61B extends laterally behind the locking portion 65 of the second main part 60B. In this embodiment, the second secondary part 61B forms a protrusion that bulges downward behind the locking portion 65 of the second main part 60B. A step portion 67 is formed at the boundary between the second secondary part 61B and the support member main body 18. The protruding amount of the second secondary part 61B is greater than the vertical distance between the locking portion 65 of the second main part 60B and the support member main body 18 so that the second secondary part 61B blocks the gap between the locking portion 65 of the second main part 60B and the support member main body 18. This prevents the wire harness 27 from coming off the second main part 60B.

Next, the effect of the vehicle seat 1 configured in this manner will be discussed in the following.

As in the first embodiment, the wire harness 27 extends in the fore and aft direction at the first retaining portion 51 and is retained by the engagement member 30 so as to be movable in the lengthwise direction. The wire harness 27 extends in the second direction at the second retaining portion 52 and is retained by the engagement member 30 so as to be movable in the lengthwise direction. Thus, the wire harness 27 is secured to the support member 17 so as to be movable in the lengthwise direction.

When an occupant is seated on the vehicle seat 1, the vibration generating device 24 moves under the load of the seated occupant. Since the wire harness 27 is movable in the lengthwise direction thereof, the wire harness 27 can move in the lengthwise direction in such a manner that the wire harness 27 is pulled out in response to the movement of the vibration generating device 24. A vehicle seat 1 is thus provided that can retain the wire harness 27 on the support member 17 while reducing the load that may be applied to the wire harness 27.

### Fifth Embodiment

The vehicle seat 1 according to the fifth embodiment of the present invention differs from the first embodiment only in the retaining structure 50, and is otherwise similar to the first embodiment. Therefore, the description of the configuration other than the retaining structure 50 is omitted in the following disclosure.

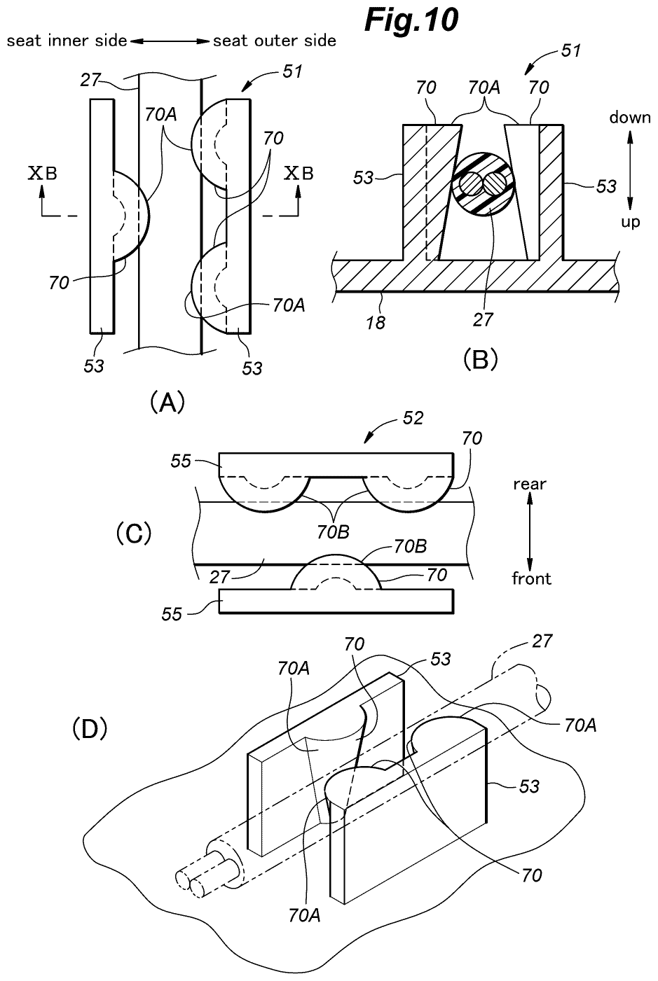

The retaining structure 50 of the fifth embodiment includes a first retaining portion 51 (see FIGS. 10(A) and (B)) and a second retaining portion 52 (see FIG. 10(C)), as in the first embodiment. The first retaining portion 51 and the second retaining portion 52 are provided at positions on the support member main body 18 that are generally similar to those in the first embodiment.

More specifically, as shown in FIGS. 10(A) and 10(B), the first retaining portion 51 includes a pair of first base portions 53 having major surfaces facing in the lateral direction, and protrusions 70 (hereinafter, first protrusions 70A) provided on the mutually opposing surfaces of the first base portions 53. The first base portions 53 are plate-shaped with the major surfaces thereof opposing each other. The first protrusions 70A protrude from the opposing surfaces of the first base portions 53 toward each other.

In this embodiment, one of the first base portions 53 is provided with a pair of first protrusions 70A and the other first base portion 53 is provided with a single first protrusion 70A. The first protrusions 70A provided on one of the first base portions 53 and the first protrusion 70A provided on the other first base portion 53 are staggered or alternate along the fore and aft direction. As shown in FIGS. 10(B) and 10(D), the protruding amount of the first protrusions 70A increase as one moves away from the support member main body 18.

As shown in FIG. 10(C), the second retaining portion 52 is provided with a pair of second base portions 55 having major surfaces facing in the lateral direction, and second protrusions 70B are provided on the opposing surfaces of the second base portions 55. The second base portions 55 are plate-shaped and have opposing major surfaces. The second protrusions 70B protrude from the opposing surfaces of the second base portions 55 toward each other. The second protrusions 70B have the same shape as the first protrusions 70A, and the second protrusions 70B provided in the two second base portions 55 of the second retaining portion 52 are arranged in a staggered arrangement. The protruding amount of the second protrusions 70B is also configured to increase as one moves away from the support member main body 18, similarly to the first protrusions 70A.

Next, the effects of the vehicle seat 1 configured in this manner will be discussed in the following.

As in the first embodiment, the wire harness 27 extends in the fore and aft direction at the first retaining portion 51 and is retained by the engagement member 30 so as to be movable in the lengthwise direction. The wire harness 27 extends in the second direction at the second retaining portion 52 and is retained by the engagement member 30 so as to be movable in the lengthwise direction. Thus, the wire harness 27 is secured to the support member 17 so as to be movable in the lengthwise direction.

When an occupant is seated on the vehicle seat 1, the vibration generating device 24 moves under the load of the seated occupant. Since the wire harness 27 is movable in the lengthwise direction thereof, the wire harness 27 can move in the lengthwise direction in such a manner that the wire harness 27 is pulled out in response to the movement of the vibration generating device 24. A vehicle seat 1 is thus provided that can retain the wire harness 27 on the support member 17 while reducing the load that may be applied to the wire harness 27.

As shown in FIGS. 10(B) and 10(C), the protruding amount of the protrusions 70 (first protrusions 70A and second protrusions 70B) increases as one moves away from the support member 17 (main body). Therefore, when the vibration generating device 24 is pulled and the wire harness 27 is pressed against the support member 17, the first retaining portion 51 is less likely to restrict the lateral movement of the wire harness 27, and the second retaining portion 52 is less likely to restrict the fore and aft movement of the wire harness 27. Therefore, even when the vibration generating device 24 is pulled and the wire harness 27 is pressed against the support member 17, the load that may be applied to the wire harness 27 can be reduced compared to the case when the protrusion amount of the protrusions 70 is constant.

### Sixth Embodiment

The vehicle seat 1 according to the sixth embodiment is different from the first embodiment in the engagement mode between the engagement member 30 and the vibration generating device 24, and is otherwise similar to the first embodiment. Therefore, a description of the configuration other than the engagement member 30 and the vibration generating device 24 will be omitted in the following disclosure.

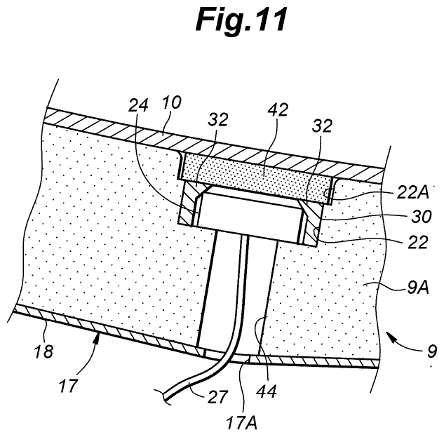

As shown in FIG. 11, each engagement member 30 according to the fifth embodiment of the present invention is accommodated in the pad member recess 22 of the pad member 9A and fixed to the wall surface that defines the pad member recess 22, similarly as in the first embodiment. As in the first embodiment, the engagement member 30 includes an engagement member main body 31 in the form of a rectangular frame structure provided with a cutout 40, and locking claws 32 provided on the engagement member main body 31.

As shown in FIG. 11, the locking claws 32 are provided on the front edge of the engagement member main body 31. The locking claws 32 abut against the edges of the front side of the vibration generating device 24, pressing the vibration generating device 24 against the bottom surface of the pad member recess 22. As in the first embodiment, the vibration generating device 24 is fixed to the wall surface that defines the pad member recess 22 in such a manner that the vibration generating device 24 is secured in the part of the pad member 9A located between the locking claws 32 and the bottom surface of the pad member recess 22.

The covering member 42 is housed in the enlarged portion 22A and positioned on the front side of the vibration generating device 24. As a result, as in the first embodiment, the covering member 42 is positioned so as to cover the vibration generating device 24 from the front side. In this embodiment, the back surface of the covering member 42 abuts on the front edge of the engagement member 30 in such a manner that a gap is created between the front surface of the vibration generating device 24 and the back surface of the covering member 42. The front surface of the covering member 42 is flush with the part of the pad member 9A surrounding the pad member recess 22.

Next, the effect of the vehicle seat 1 configured in this manner will be discussed in the following. The vibration generating device 24 engages with the engagement member 30, and the engagement member 30 is secured to the pad member 9A. Since the engagement member 30 is made of a harder material than the pad member 9A, it is less likely to deform than the pad member 9A when a load from the seated occupant is applied. Therefore, the vibration generating device 24 is less likely to move relative to the pad member 9A than when the vibration generating device 24 is fitted into the pad member recess 22 provided in the pad member 9A and frictionally locked therein.

The first to sixth embodiments of the present invention have been described above, but the present invention is not limited to the above embodiments and can be modified and implemented in a wide range of different ways.

In the first to sixth embodiments, the first retaining portion 51 was located on the outer side of the seat and in front of the second retaining portion 52, but the arrangement of the first retaining portion 51 and the second retaining portion 52 is not limited to this pattern.

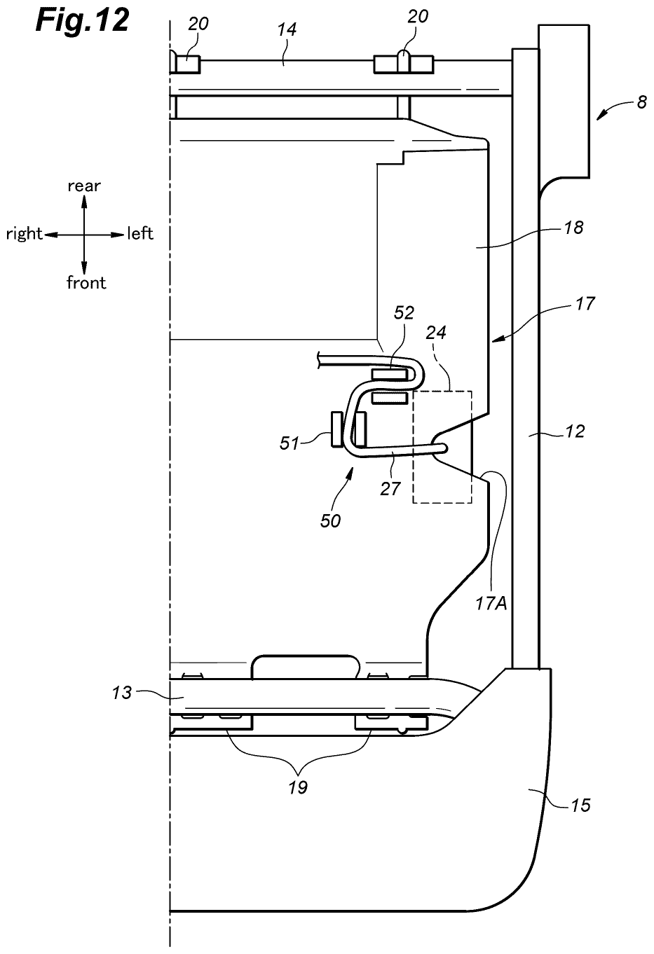

FIG. 12 shows a modified arrangement of the first retaining portion 51 and the second retaining portion 52. As shown in FIG. 12, the second retaining portion 52 may be located on the outer side of the seat and behind the first retaining portion 51. In this case, the length required for the wire harness 27 is increased, but since the first base portion 53 and the second base portion 55 are spaced apart from each other, the stress that may be applied to the part of the wire harness 27 located between the first retaining portion 51 and the second retaining portion 52 can be reduced.

Furthermore, as shown in FIG. 6, the first base portion 53 and the second base portion 55 may be joined to each other and the first retaining portion 51 and the second retaining portion 52 may be connected to each other. As a result, a groove 80 extends generally continuously between the first base portion 53 and the second base portion 55.

Even when the first base portion 53 and the second base portion 55 are joined to each other and configured to be continuous in this way, the wire harness 27 can be secured to the support member main body 18 while restricting movement in the direction perpendicular to the lengthwise direction. Furthermore, when at least one of the first base portions 53 and at least one of the second base portions 55 are connected to each other, the movement of the wire harness 27 can be more firmly restricted than when the first base portions 53 and the second base portions 55 are not connected to each other at all. Furthermore, since the rigidity of the first retaining portion 51 and the second retaining portion 52 is increased by connecting them, the first retaining portion 51 and the second retaining portion 52 are less likely to deform than when they are separated.

In the first to sixth embodiments, the vibration generating device 24 was described as being provided in the seat cushion 2, but the present invention is not limited to this example, and the vibration generating device 24 may also be provided in the seat back 3. In the above embodiments, the electrical device provided in the vehicle seat 1 consisted of the vibration generating device 24, but the electrical device may also be another electrical/electronic device (such as a blower and a seat heater). In addition, in the above embodiments, the vibration generating device 24, which is an electrical device, is completely housed inside the pad member recess 22, but the present invention is not limited to this aspect, and the electrical device may also be at least partly received in the pad member recess 22 and engaged by the engagement member 30 at a part thereof. In addition, the shape of the engagement member 30 is not limited to a form of a frame structure, and may be any shape that matches the shape of the electrical device. For example, the engagement member 30 may be hook-shaped to conform to the shape of the electrical device. In addition, the engagement member 30 may be located in any position as long as the engagement member 30 is secured to part of the pad member 9A on the side of the opening away from the bottom wall 22B (upper side of the bottom wall 22B when provided on the seat cushion 2, and forward of the bottom wall 22B when provided on the seat back 3).

In the first to sixth embodiments, the first retaining portion 51 was configured to restrict the movement of the wire harness 27 in the lateral direction (first direction), and the second retaining portion 52 was configured to restrict the movement of the wire harness 27 in the fore and aft direction (second direction). However, the direction in which the movement of the wire harness 27 is restricted by the first retaining portion 51 and the direction in which the movement of the wire harness 27 is restricted by the second retaining portion 52 may be any direction as long as they are orthogonal to each other. Also, in the above embodiments, the support member main body 18 extended along the seat cushion frame structure 8, but the present invention is not limited to this example. For example, the support member main body 18 may be configured to bend downwards at approximately the center in the fore and aft direction and extend at a small angle to the extending direction of the seat cushion frame structure 8.

### Seventh Embodiment

A vehicle seat according to the seventh embodiment of the present invention as applied to a seat 101 mounted on a vehicle such as an automobile will be described in the following with reference to the appended drawings. In the following disclosure, the lateral and vertical directions will be defined based on the assumption that the traveling direction coincides with the fore and aft direction.

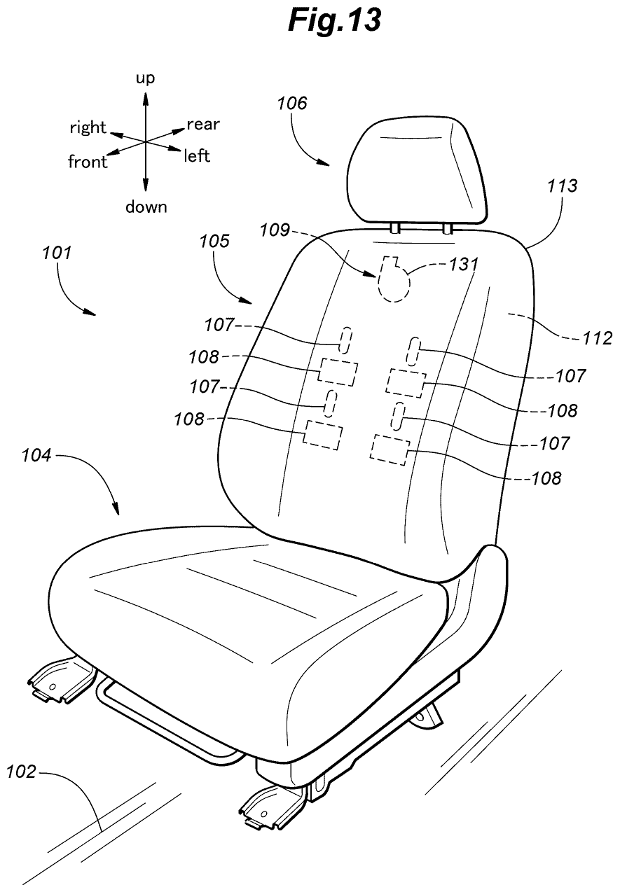

As shown in FIG. 13, the seat 101 is mounted on a floor 102 that defines the bottom of the vehicle's cabin so as to face forward. In this embodiment, the seat 101 constitutes a front row seat.

The seat 101 includes a seat cushion 104 secured to the floor 102, a seat back 105 connected to a rear part of the seat cushion 104, and a headrest 106 provided on the upper end of the seat back 105. The seat cushion 104 supports the buttocks and thighs of the occupant from below. The seat back 105 supports the lumbar region and back of the occupant from behind.

The seat 101 further includes a plurality of vibration devices 107 for applying vibrations to the occupant, a plurality of air cells 108, and an air blower 109. Each air cell 108 expands when fluid is supplied thereto, and contracts when the fluid is discharged therefrom. The air blower 109 blows air toward the occupant. In another embodiment, the seat 101 may have an air intake device that draws in air toward the occupant instead of the air blower 109.

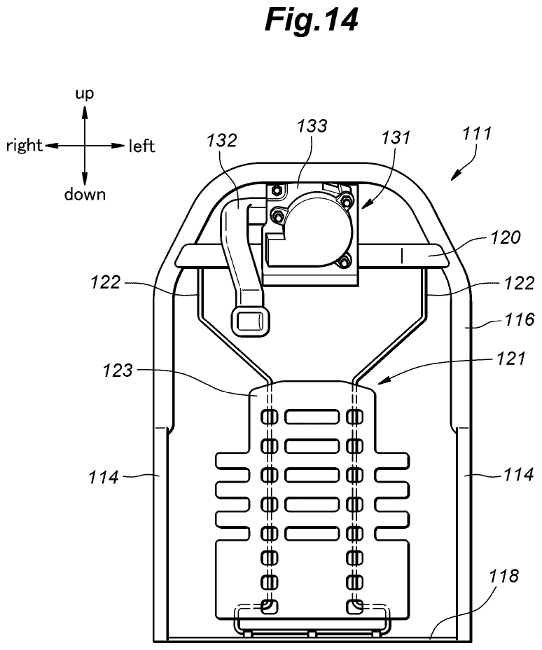

As shown in FIG. 14 as well, the seat back 105 is provided with a seat back frame structure 111 that forms the skeletal frame structure, and a seat back pad 112 that is supported by the seat back frame structure 111. The seat back 105 also has a skin material 113 that is placed over the seat back pad 112 and the seat back frame structure 111. The vibration devices 107 and the air cells 108 are positioned between the seat back pad 112 and the skin material 113.

As shown in FIG. 14, the seat back frame structure 111 may have a per se known configuration including a pair of seat back side members 114 extending vertically on either side, an upper member 116 connected between the upper ends of the left and right seat back side members 114, a lower member 118 extending laterally between the lower ends of the left and right seat back side members 114, and a middle member 120 extending laterally between the left and right seat back side members 114. The middle member 120 may be positioned between the upper member 116 and the lower member 118. The seat back frame structure 111 may be formed of, for example, metal.

The seat back 105 further includes a pressure receiving member 121 supported by the seat back frame structure 111. The pressure receiving member 121 may have a per se known configuration, for example, including metal wires 122 spanned across the seat back frame structure 111 and a plate-like member 123 supported by the wires 122 and facing in the fore and aft direction. In this embodiment, the upper ends of the wires 122 are connected to the middle member 120, and the lower ends of the wires 122 are connected to the lower member 118. The plate-like member 123 is connected to the front side of the wires 122. The plate-like member 123 may be made of a resin material, for example.

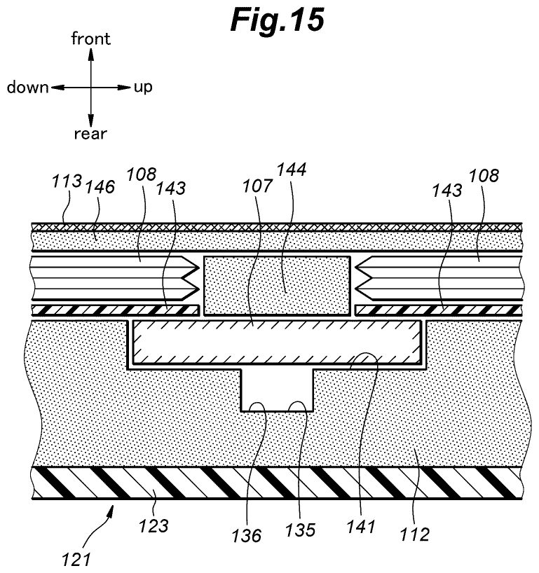

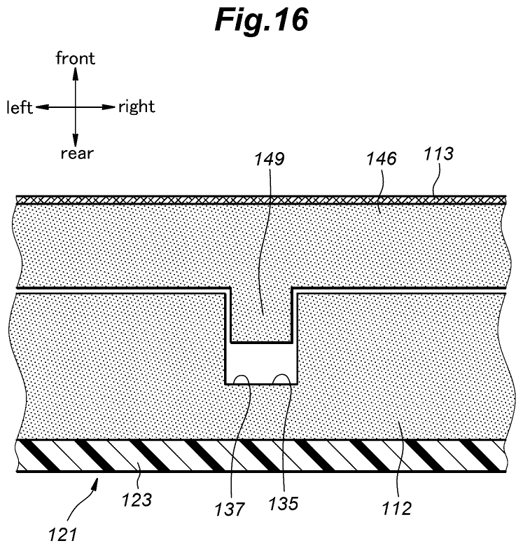

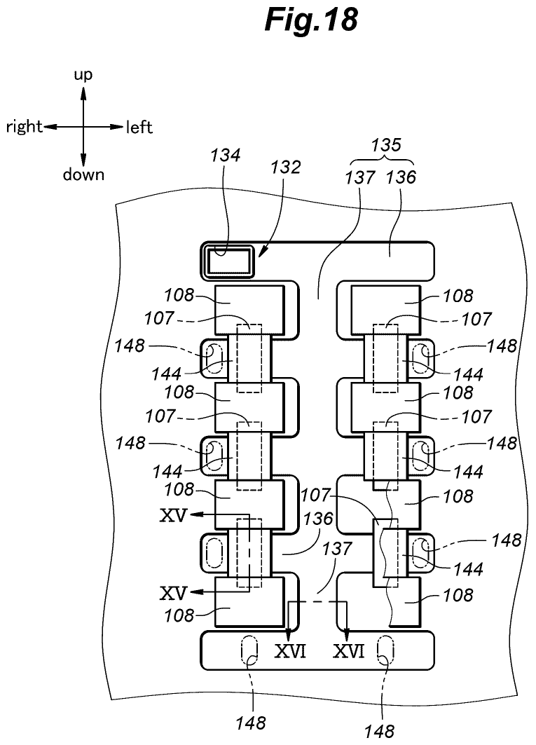

As shown in FIGS. 15 and 16, the seat back pad 112 is placed on the front side of the pressure receiving member 121, i.e., on the front side facing the occupant (the seated person side). The back side of the seat back pad 112, i.e., the side of the rear side facing away from the occupant, may abut against the front side of the plate-like member 123. As a result, the load applied from the front to the seat back pad 112 via the skin material 113 is transmitted to the seat back frame structure 111 via the pressure receiving member 121. The seat back pad 112 may be formed of a foamed resin such as urethane foam. It should be noted that FIG. 15 is a sectional view taken along line XV-XV of FIG. 18, and FIG. 16 is a sectional view taken along line XVI-XVI of FIG. 18.

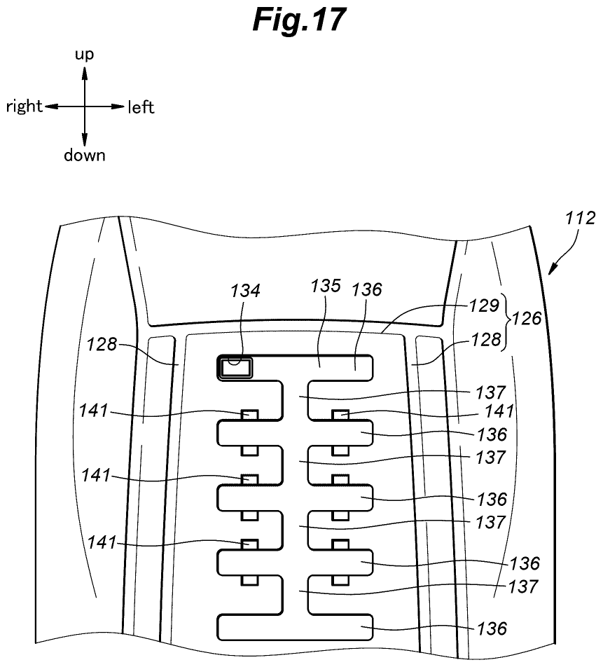

As shown in FIG. 17, the seat back pad 112 may be provided with a plurality of grooves 126 for pulling down the skin material 113. Each groove 126 is recessed rearward from the front surface of the seat back pad 112 and extends along the surface of the seat back pad 112. In this embodiment, there are a pair of vertical listing grooves 128 extending in the vertical direction on either side, and a horizontal listing groove 129 extending in the lateral direction and crossing the vertical listing grooves 128.

Each groove 126 may be provided with a plurality of clips (not shown) for retaining the skin material 113 to the seat back 105 in the bottom part thereof. Each clip may have a per se known configuration, for example, including a base sheet embedded in the seat back pad 112 and a pair of locking pieces protruding from the base sheet at the bottom of the groove into the interior of the groove 126. The skin material 113 is retained to the seat back 105 by locking a plurality of locking parts provided on the skin material 113 to the corresponding locking pieces.

As shown in FIG. 14, the blower 109 includes a blower main body 131 supported by the seat back frame structure 111, and a duct 132 connected to the blower main body 131. The blower main body 131 is positioned between the upper member 116 and the middle member 120. The blower main body 131 may be connected to at least one of the upper member 116 and the middle member 120 via a bracket 133. The blower main body 131 may be a centrifugal fan, or may be a sirocco fan, for example.

A heat source or a cooling source may be provided on either the air inlet side or the air outlet side of the blower main body 131. The heat source may be, for example, a heat sink or a PTC heater (Positive Temperature Coefficient heater). The cooling source may be, for example, a Peltier device. In this way, the blower 109 is able to send out warm air or cold air from a part located on a side of the seated occupant.

The duct 132 may be formed to have a rectangular cross section. One end of the duct 132 is connected to the blower main body 131, and the other end of the duct 132 passes between the upper member 116 and the middle member 120 from the rear to the front. The opening of the other end of the duct 132 faces forward.

As shown in FIG. 17, the seat back pad 112 is further provided with a ventilation hole 134 passed through in the fore and aft direction and a ventilation groove 135 communicating with the ventilation hole 134. In this embodiment, the ventilation hole 134 is formed in a rectangular shape when viewed from the top-bottom direction. The ventilation hole 134 is provided under the horizontal listing groove 129 and to the left of the right vertical listing groove 128. The duct 132 is communicated with the ventilation hole 134. More specifically, the other end of the duct 132 may be inserted into the ventilation hole 134.

As shown in FIGS. 15 to 17, the ventilation groove 135 is recessed rearward from the surface of the seat back pad 112 and extends along the surface of the seat back pad 112. The ventilation groove 135 is communicated with the ventilation hole 134. More specifically, the ventilation hole 134 is formed in a part of the bottom of the ventilation groove 135. The ventilation groove 135 includes a plurality of lateral groove segments 136 extending in the lateral direction and a plurality of vertical groove segments 137 extending in the vertical direction and connected to the lateral groove segments 136. In this embodiment, five lateral groove segments 136 are provided spaced apart from each other in the vertical direction. Each of the vertical groove segments 137 is configured to connect adjacent lateral groove segments 136 to each other. Each vertical groove segment 137 is provided in the lateral center of the lateral groove segments 136. The ventilation hole 134 is formed at the right end of the uppermost lateral groove segment 136.

As shown in FIG. 18, each vibration device 107 has a rectangular parallelepiped shape. Each vibration device 107 may have a per se known configuration including, for example, a coil, a magnet, and a yoke. The magnetic field generated by the coil changes as the direction of the current flowing through the coil is changed periodically. This causes the yoke to which the magnet is connected to vibrate in response to the change in the magnetic field. The vibration devices 107 are preferably positioned so that the direction of their vibration is perpendicular to the front surface of the seat back pad 112, but may also be positioned so that the direction of their vibration is parallel to the front surface of the seat back pad 112.

The vibration devices 107 are positioned on the front side of the seat back pad 112. As shown in FIGS. 15 to 17, the seat back pad 112 is provided with a plurality of first recesses 141 for receiving the corresponding vibration devices 107 therein. Each first recess 141 consists of a bottomed recess that is recessed rearward from the front surface of the seat back pad 112. Each first recess 141 is formed in a rectangular shape when viewed from the front. Each first recess 141 is configured such that the vibration device 107 is prevented from coming into contact with the occupant so that the discomfort that may be experienced by the occupant can be minimized.

As shown in FIG. 15, each first recesses 141 is communicated with the ventilation groove 135. In this conjunction, the width of the ventilation groove 135 is narrower than the width of the first recesses 141. Each first recess 141 is positioned forward of the ventilation groove 135. More specifically, the bottom surface of each first recess 141 is located forward of the bottom surface of the ventilation groove 135. In this conjunction, a part of the opening of the ventilation groove 135 is provided on the bottom surface of the first recess 141. In this embodiment, each first recess 141 is communicated with the corresponding lateral groove segments 136, except for that the uppermost lateral groove segment 136 and the lowermost lateral groove segment 136 are not communicated with any first recess. More specifically, each first recess 141 is provided on the left or right end of the corresponding lateral groove segment 136. When the vibration devices 107 are received in the corresponding first recesses 141, each vibration device 107 blocks a part of the opening of the ventilation groove 135 provided on the bottom surface of the first recess 141. Therefore, the air passing through the ventilation groove 135 is prevented from leaking out of the first recess 141.

As shown in FIGS. 15, 16, and 18, the air cells 108 are positioned on the front side of the seat back pad 112. More specifically, the air cells 108 are positioned on the front side of the vibration devices 107. In this embodiment, each air cell 108 is positioned on a part of the front surface of the seat back pad 112 located between the two lateral groove segments 136 that vertically adjoin to each other. Therefore, the air cells 108 are positioned on the seat back pad 112 so as to be spaced from each other.

When each vibration device 107 is received in the corresponding first recess 141, the vibration device 107 is positioned between two air cells 108 that are vertically adjoining to each other when viewed from the fore and aft direction. At this time, the vibration device 107 overlaps with these air cells 108 when viewed from the fore and aft direction. More specifically, when viewed from the front, the upper end of each vibration device 107 overlaps with the lower end of the upper air cell 108. Also, the lower end of each vibration device 107 overlaps with the lower air cell 108.

The air cells 108 are each fixed to the seat back pad 112 by a fixing member. In this embodiment, the fixing member includes a double-sided tape 143. Each double-sided tape 143 is placed on the front surface of the seat back pad 112. More specifically, one of the surfaces of the double-sided tape 143 is adhered to a part of the front surface of the seat back pad 112 located between the lateral groove segments 136 vertically adjacent to each other. The rear surface of the corresponding air cell 108 is adhered to the other surface of the double-sided tape 143. In this way, each air cell 108 is fixed to the seat back pad 112. A part of each double-sided tape 143 may extend beyond the air cell 108 in the vertical direction. In such a case, the upper end of the corresponding vibration device 107 may be adhered to the lower end of the double-sided tape 143 located immediately above, and the lower end of this vibration device 107 may be adhered to the upper end of the double-sided tape 143 located immediately below. In this way, each vibration device 107 can be secured to the seat back pad 112 in a stable manner.

Spacers 144 are placed between the vertically adjacent air cells 108. In other words, when viewed in the fore and aft direction, each vibration device 107 overlaps with the vertically adjacent air cells 108 and the spacers 144. The spacers 144 are each formed in a plate shape facing the fore and aft direction. Each spacer 144 is preferably positioned in the vertical center of the corresponding vibration device 107. As a result, the spacers 144 fill the space between the adjacent air cells 108 in the vertical direction, making it easier for the vibration of the vibration device 107 to be transmitted to the occupant. The front surface of each spacer 144 is preferably positioned on the same plane as the front surface of the deflated air cells 108. Thereby, steps are prevented from being created between the spacers 144 and the air cells 108. Therefore, discomfort to the seated occupant can be further reduced. The spacers 144 may be formed of the same foam resin as the seat back pad 112, or may be formed of a foam resin softer than the seat back pad 112. Each spacer 144 may be fixed to the corresponding vibration device 107 with a double-sided tape 143. In another embodiment, the spacers 144 may extend in the lateral direction along the corresponding lateral groove segments 136. In this case, the left and right ends of each spacer 144 may overlap with the left and right vibration devices 107 when viewed from the fore and aft direction.

A cover pad 146 is placed on the front side of the seat back pad 112. The cover pad 146 is located between the seat back pad 112 and the skin material 113. The cover pad 146 covers the ventilation groove 135. The cover pad 146 is formed in a plate shape facing the fore and aft direction. The cover pad 146 may be formed of the same foam resin as the seat back pad 112, or may be formed of a foam resin harder than the seat back pad 112. The cover pad 146 can fill the gap between the air cells 108, the spacers 144 and the seat back pad 112. This further reduces the discomfort of the seated occupant.

The cover pad 146 is provided with a plurality of through holes 148 (see FIG. 18) penetrating in the fore and aft direction. The through holes 148 overlap with the ventilation groove 135 when viewed from the fore and aft direction. More specifically, each through hole 148 overlaps with the left and right ends of the corresponding lateral groove segment 136. More specifically, each through hole 148 is positioned so as not to overlap with the first recesses 141 when viewed from the fore and aft direction. The through holes 148 allow the blower main body 131 to blow air toward the front side (occupant side) of the seat back pad 112 via the duct 132, the ventilation hole 134, the ventilation groove 135, and the through holes 148. Therefore, the cover pad 146 cooperates with the seat back pad 112 to form a flow path for the air forwarded from the blower main body 131.

The cover pad 146 may have at least one protrusion 149 protruding rearward from the rear surface of the cover pad 146. The protrusion 149 extends along the surface of the cover pad 146. More specifically, the protrusion 149 is provided so as to overlap with a part of the ventilation groove 135 when viewed from the fore and aft direction. The protrusion 149 is provided so as to avoid the through holes 148. The protrusion 149 is provided at a position that does not overlap with the first recesses 141 when viewed from the fore and aft direction.

The protrusion 149 provided on the cover pad 146 may be configured to enter the ventilation groove 135 when the cover pad 146 is placed over the seat back pad 112. In this case, the upper and lower side surfaces of the protrusion 149 that protrudes into the lateral groove segment 136 may abut against the upper and lower side surfaces of the lateral groove segment 136. Also, the left and right side surfaces of the protrusion 149 that protrudes into the vertical groove segment 137 may abut against the left and right side surfaces of the vertical groove segment 137. This allows the protrusion 149 to block the opening at the front end of the ventilation groove 135. Therefore, air passing through the ventilation groove 135 is sent to the occupant side from the through holes 148 provided in the cover pad 146. The projecting surface of the protrusion 149 facing rearward may be on the same plane as the bottom surface of the first recess 141.

In other embodiments, the seat back 105 may have a plate-shaped member arranged between the seat back pad 112 and the cover pad 146. The ventilation groove 135 may be formed in the plate-shaped member. In this case, the ventilation groove 135 may be formed so as to penetrate the plate-like member in the thickness direction and extend along the surface of the plate-like member. In this case, the plate-like member may be provided with first recesses 141 for receiving the vibration devices 107. By replacing the plate-like member, the shape of the ventilation groove 135 and the arrangement of the vibration devices 107 can be changed. Therefore, the shape of the ventilation groove 135 and the arrangement of the vibration devices 107 can be made more flexible.

A manufacturing method for the seat 101 configured as above, particularly a manufacturing method for the seat back 105, will be described in detail. The various processes that are described below can be performed by an operator who manufactures the seat 101.

First, the seat back pad 112 is prepared. The seat back pad 112 may be formed by injection foam molding or extrusion foam molding of a foam resin such as urethane foam. At this time, the seat back pad 112 may be formed with the listing grooves 126, the first recesses 141, the ventilation holes 134, and the ventilation groove 135. Each listing groove 126 may be provided with a plurality of listing clips.

Next, the vibration devices 107 are received in the corresponding first recesses 141 (first step). Then, the double-sided tapes 143 are placed on the front surface of the seat back pad 112 (second step). More specifically, one surface of each double-sided tape 143 is adhered to a part of the front surface of the seat back pad 112 located between the vertically adjoining lateral groove segments 136. At this time, the upper end of each vibration device 107 may be adhered to the lower side of the upper double-sided tape 143, and the lower end of the vibration device 107 may be adhered to the upper side of the lower double-sided tape 143.

Next, each air cell 108 is fixed to the corresponding double-sided tape 143 (third step). More specifically, the rear surface of each air cell 108 is adhered to the other surface of the double-sided tape 143. Each air cell 108 is positioned on the front surface of the seat back pad 112 so as to be located between the vertically adjoining lateral groove segments 136. At this time, each vibration device 107 overlaps with the two vertically adjoining air cells 108 when viewed from the fore and aft direction.

Next, the spacers 144 are each positioned between the corresponding vertically adjoining air cells 108 (fourth step). More specifically, each spacer 144 is positioned in front of the corresponding vibration device 107. Next, the cover pad 146 is placed on the front side of the seat back pad 112. At this time, it is preferable that the protrusion 149 provided on the cover pad 146 is inserted into the ventilation groove 135.

Next, the blower main body 131 of the blower 109 is attached to the seat back frame structure 111. The blower main body 131 may be attached to at least one of the upper member 116 and the middle member 120 via a bracket 133, for example. The duct 132 connected to the blower main body 131 is passed between the upper member 116 and the middle member 120 from the rear to the front. The opening of the other end of the duct 132 is positioned so as to face forward.

Next, the seat back pad 112 is placed over the seat back frame structure 111 from the front. At this time, a part of the rear surface of the seat back pad 112 may abut against the front surface of the pressure receiving member 121. The other end of the duct 132 of the blower 109 may be inserted into the ventilation hole 134 provided in the seat back pad 112.

Next, the skin material 113 is placed over the seat back pad 112 from the front. The skin material 113 is retained on the seat back pad 112 by the locking portions provided on the skin material 113 being locked to the locking portions of the clips provided in the listing groove 126. In this manner, the seat back 105 having the vibration devices 107 and the air cells 108 placed on the surface thereof is manufactured.

Since the vibration devices 107 and the air cells 108 overlap one another when viewed from the front, they are closely packed together when viewed from the fore and aft direction. Therefore, the vibration devices 107 and the air cells 108 can be arranged on the surface of the seat back pad 112 in a favorable manner. Furthermore, since each first recess 141 is connected to the ventilation groove 135, the vibration devices 107 and the ventilation groove 135 are closely packed together when viewed from the fore and aft direction. Therefore, the vibration devices 107 and the air cells 108, as well as the ventilation groove 135, can be arranged on the surface of the seat back pad 112 in a favorable manner even though the seat 101 is fitted with the air blower 109.

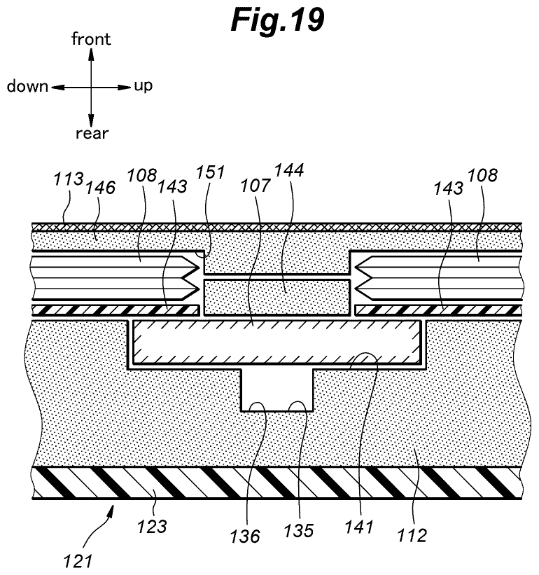

The shape of the cover pad 146 may be changed. For example, as shown in FIG. 19, the cover pad 146 may be provided with a plurality of second recesses 151 recessed from the back surface of the cover pad 146 toward the front surface. In this embodiment, the second recesses 151 are formed so as to recess forward from the rear surface of the cover pad 146. Each second recess 151 receives a corresponding air cell 108. This prevents each air cell 108 from moving along the surface of the seat back pad 112. In addition, the steps between the air cells 108 and the seat back pad 112 are reduced, thereby minimizing discomfort experienced by the occupant.

In other embodiments, the second recesses 151 may be provided in the seat back pad 112. More specifically, the second recesses 151 may be provided so as to be recessed rearward from the front surface of the seat back pad 112. The second recesses 151 may be connected to the first recesses 141 that house the vibration devices 107. More specifically, each second recess 151 may be provided so as to protrude outward from the upper and lower edges of the first recess 141. The bottom surfaces of the second recesses 151 may be located on the front side of the bottom surfaces of the first recesses 141.

This concludes the explanation of the seventh embodiment, but the present invention can be widely modified and implemented without being limited to the embodiment described above. For example, the air cells 108, the vibration devices 107, and air blower 109 were provided in the seat back 105, but may also be provided in the seat cushion 104.

### Eighth Embodiment

A vehicle according to an eighth embodiment of the present invention will be described in the following with reference to the appended drawings. In the following description, front/rear, left/right, and up/down are defined with reference to the vehicle.

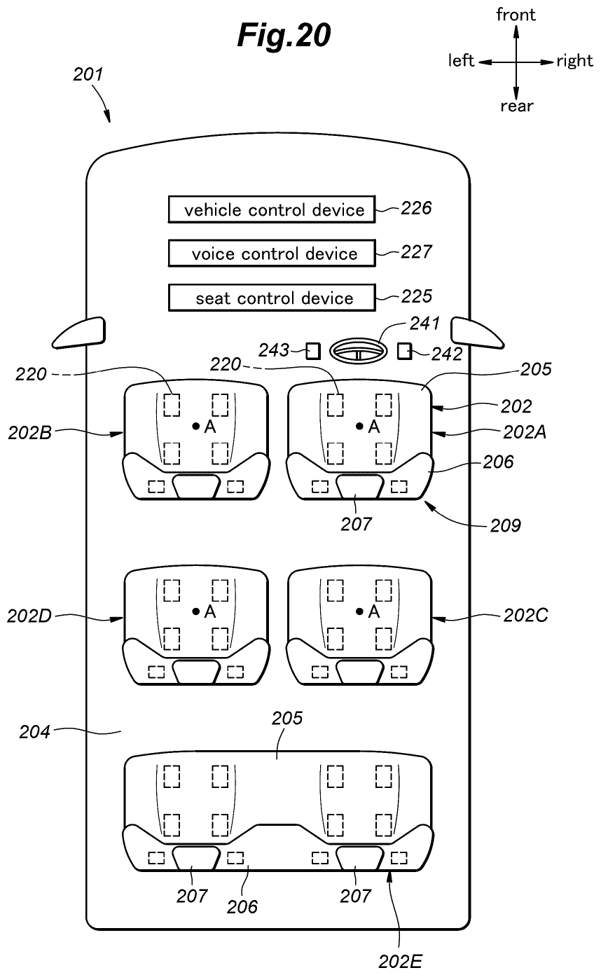

As shown in FIG. 20, the vehicle 201 is provided with a plurality of seats 202 arranged in the cabin thereof. The seats 202 include a right front seat 202A (first seat), a left front seat 202B, a right middle seat 202C, a left middle seat 202D, and a rear seat 202E. The right front seat 202A, the left front seat 202B, the right middle seat 202C, and the left middle seat 202D are single seats. The rear seat 202E is a two-seater. The right front seat 202A constitutes the driver's seat. The right front seat 202A, the left front seat 202B, the right middle seat 202C, and the left middle seat 202D may have the same configuration.

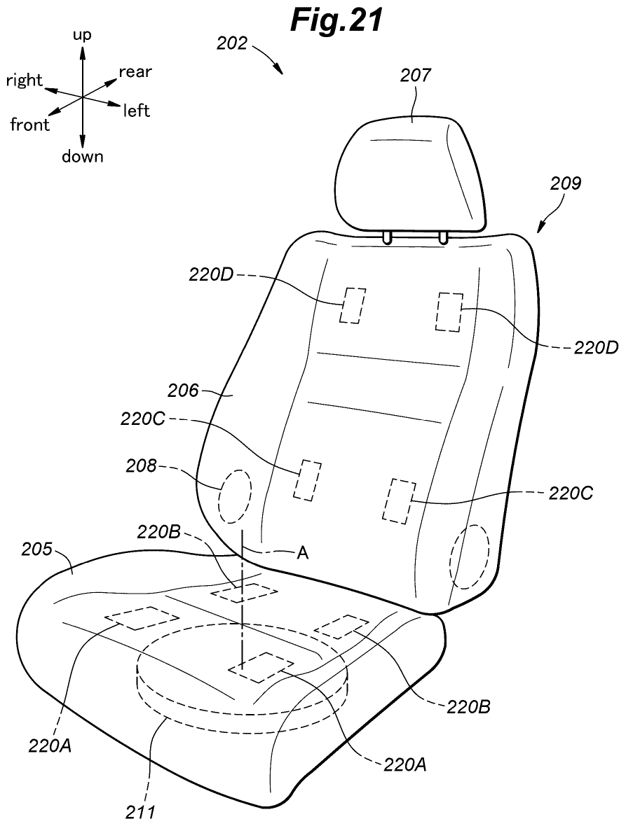

As shown in FIGS. 20 and 21, each seat 202 has a seat cushion 205 provided on the floor 204, a seat back 206 extending upward from a rear part of the seat cushion 205, and a headrest 207 connected to the upper end of the seat back 206. The seat back 206 is rotatably supported on the seat cushion 205 via a reclining device 208. In other words, the seat back 206 is supported so as to be able to tilt with respect to the seat cushion 205. The seat cushion 205 and the seat back 206 constitute a seat main body 209.

The seat main body 209 is rotatably provided on the floor 204 via a rotation device 211. More specifically, the seat cushion 205 is supported on the floor 204 so as to be rotatable around a rotational axis A extending vertically (in a direction perpendicular to the floor 204). The rotation device 211 may have an actuator that generates a driving force to rotate the seat main body 209. The seat cushion 205 may also be supported on the floor 204 via a slide device so as to be movable back and forth. In this case, the rotational axis A may be arranged so as to be movable back and forth. The slide device may be interposed between the floor 204 and the rotation device 211.

The seat cushion 205 includes a seat cushion frame structure, a pad supported by the seat cushion frame structure, and a skin material that covers the pad. The seat back 206 has a seat back frame structure, a pad supported by the seat back frame structure, and a skin material that covers the pad. The seat back 206 is supported on the seat cushion 205 via a reclining device 208 so as to be rotatable (also referred to as tiltable) around a laterally extending axis.

The seat 202 is provided with a plurality of vibration devices 220. The vibration devices 220 may include first to fourth vibration devices 220A, 220B, 220C, and 220D. The first to fourth vibration devices 220A, 220B, 220C, and 220D may be arranged in laterally arranged pairs. The first vibration devices 220A arranged in a lateral pair and the second vibration devices 220B arranged in a lateral pair may be provided on the seat cushion 205. The third vibration devices 220C arranged in a lateral pair and the fourth vibration devices 220D arranged in a lateral pair may be provided on the seat back 206.

The second vibration devices 220B is provided closer to the seat back 206 than the first vibration devices 220A. In other words, the left and right first vibration devices 220A are provided in a front part of the seat cushion 205, and the left and right second vibration devices 220B are provided in a rear part of the seat cushion 205. The first vibration devices 220A and the second vibration devices 220B may be placed in recesses formed in the upper surface of the pad constituting the seat cushion 205. Alternatively, the first vibration devices 220A and the second vibration devices 220B may be disposed in recesses formed in the lower surface of the pad constituting the seat cushion 205.

The left and right third vibration devices 220C are provided in a lower part of the seat back 206, and the left and right fourth vibration devices 220D are provided in an upper part of the seat back 206. The third vibration devices 220C and the fourth vibration devices 220D may be disposed in recesses formed in the front surface of the pad constituting the seat back 206. Alternatively, the third vibration devices 220C and the fourth vibration devices 220D may be disposed in recesses formed in the rear surface of the pad constituting the seat back 206.

The vibration devices 220 each consist of an eccentric rotating mass vibration motor or a linear resonant actuator. The eccentric rotating mass vibration motor includes an electric motor and an eccentric weight coupled to the rotating shaft of the electric motor. The electric motor rotates the eccentric weight to generate vibration. The linear resonant actuator may include a coil, a magnet, and a yoke. The magnetic field generated by the coil is changed as the direction of the current flowing through the coil is changed periodically. As a result, the yoke to which the magnet is coupled vibrates in response to the change in the magnetic field. The eccentric rotating mass vibration motors may be provided on the seat cushion 205 and the seat back 206 so that the vibration direction is perpendicular to the seat surface.

Preferably, one of the pairs of the first vibration devices 220A and the second vibration devices 220B consists of eccentric rotating mass vibration motors, and the other pair of the first vibration device 220A and the second vibration device 220B consists of linear resonant actuators. In this embodiment, the left and right first vibration devices 220A are eccentric rotating mass vibration motors, and the left and right second vibration devices 220B are eccentric rotating mass vibration motors.

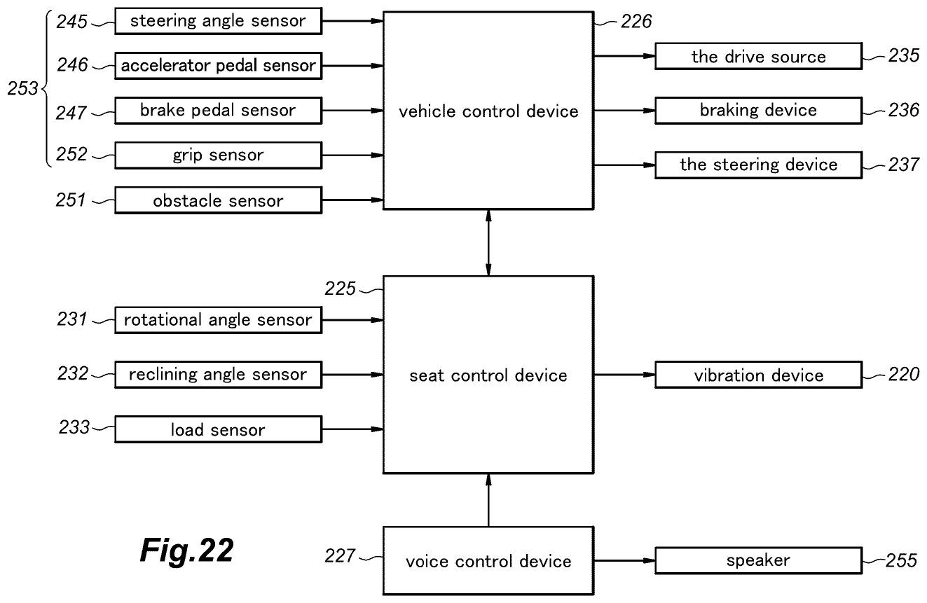

As shown in FIG. 22, the vehicle 201 is provided with a seat control device 225, a vehicle control device 226, and a voice control device 227. Each of the seat control device 225, the vehicle control device 226, and the voice control device 227 consists of an electronic control device (ECU) including a processor such as a CPU, non-volatile memory (ROM), and volatile memory (RAM). The seat control device 225, the vehicle control device 226, and the voice control device 227 execute various applications by performing arithmetic processing in the processor in accordance with a program stored in the non-volatile memory. The seat control device 225, the vehicle control device 226, and the voice control device 227 may be configured as one piece of hardware, or may be configured as a unit consisting of multiple pieces of hardware. When the seat control device 225, the vehicle control device 226, and the voice control device 227 are independent pieces of hardware, the seat control device 225, the vehicle control device 226, and the voice control device 227 are connected to one another so that they can communicate with one another.

The seat control device 225 controls the vibration devices 220. The seat control device 225 is connected to a rotational angle sensor 231, a reclining angle sensor 232, and a load sensor 233. The rotational angle sensor 231 detects a rotational angle of the seat main body 209 centered on a rotational axis extending in the vertical direction relative to the floor 204. The rotational axis may be set to extend in a direction perpendicular to the floor 204. The rotational angle is set to 0 degrees when the seat main body 209 faces the front of the vehicle 201, and a positive angle (0 degrees to 180 degrees) is set in the clockwise direction, and a negative angle (0 degrees to −180 degrees) is set in the counterclockwise direction. The rotational angle sensor 231 may be provided in the rotation device 211. The reclining angle sensor 232 detects the reclining angle, which is the angle of the seat back 206 with respect to the vertical plane. The vertical plane here may be defined as a plane perpendicular to the floor 204. The reclining angle sensor 232 may also detect the rotational angle of the seat back 206 with respect to the seat cushion 205. The reclining angle sensor 232 may be provided between the seat cushion 205 and the seat back 206. The rotational angle sensor 231 and the reclining angle sensor 232 may be a per se known rotational angle sensor 231 such as a potentiometer or a rotary encoder. The load sensor 233 is provided in the seat cushion 205 and measures the load applied by the occupant. The load sensor 233 may be, for example, a piezoelectric device.

The vehicle control device 226 can execute multiple driving modes including an automatic driving mode and a manual driving mode. In the automatic driving mode, the vehicle control device 226 controls the drive source 235, the braking device 236, and the steering device 237 of the vehicle 201 based on signals from various sensors to drive the vehicle 201. The drive source 235 may be an electric motor or an internal combustion engine. In the manual driving mode, the vehicle control device 226 controls the drive source 235, the braking device 236, and the steering device 237 of the vehicle 201 based on the driving operations of the driver applied to the steering wheel 241, the accelerator pedal 242, and the brake pedal 243 to drive the vehicle 201. The steering wheel 241 is provided with a steering angle sensor 245 that detects the steering angle. The accelerator pedal 242 is provided with an accelerator pedal sensor 246 that detects the position of the accelerator pedal 242. The brake pedal 243 is provided with a brake pedal sensor 247 that detects the position of the brake pedal 243. The steering angle sensor 245, the accelerator pedal sensor 246, and the brake pedal sensor 247 are connected to the vehicle control device 226.

The vehicle control device 226 can switch the driving mode of the vehicle 201 between an automatic driving mode and a manual driving mode. The vehicle control device 226 may switch the driving mode from the automatic driving mode to the manual driving mode when the position of the vehicle 201 is within a predetermined range from the end point of the automatic driving. The end point of the automatic driving may be set, for example, at an exit of a highway. In addition, the vehicle control device 226 may set the end point of the automatic driving to a position a predetermined distance ahead of the current position when an abnormality is detected in any of the devices or the occupant of the vehicle 201. The predetermined distance may be set in advance.

The vehicle control device 226 is connected to an obstacle sensor 251 that detects obstacles present around the vehicle 201 (vehicle body). The obstacle sensor 251 may be a radar, a lidar, a sonar, or the like. The vehicle control device 226 acquires obstacle information including the positions of obstacles present around the vehicle 201 based on a signal from the obstacle sensor 251.

The steering wheel 241 is provided with a grip sensor 252. The grip sensor 252 may be any one of a capacitance sensor, a pressure sensor, and a membrane switch provided on the steering wheel 241. The vehicle control device 226 and the seat control device 225 determine if the steering wheel 241 is being gripped based on the signal from the grip sensor 252. The steering angle sensor 245, the accelerator pedal sensor 246, the brake pedal sensor 247, and the grip sensor 252 constitute an input device 253 that accepts manual driving operations by the driver.

The voice control device 227 controls the speaker 255 based on voice information. The speaker 255 is provided in the vehicle 201. The voice control device 227 may use voice information stored in memory, acquire voice information from a recording medium such as a CD or a DVD, acquire voice information from radio waves or TV waves, or acquire voice information via the Internet. The voice control device 227 may generate a voice output signal based on the voice information and control the speaker 255 by the voice output signal. The voice control device 227 also outputs a voice output signal to the seat control device 225.

The control action executed by the seat control device 225 will be described in the following. When the vehicle control device 226 executes an automatic driving end control for switching the driving mode from the automatic driving mode to the manual driving mode, the seat control device 225 executes a notification control for vibrating the vibration devices 220 in order from the one located at the rear. In the notification control, the seat control device 225 acquires the front-rear positions of the first vibration devices 220A and the second vibration devices 220B based on the rotational angle around the rotational axis of the right front seat 202A.

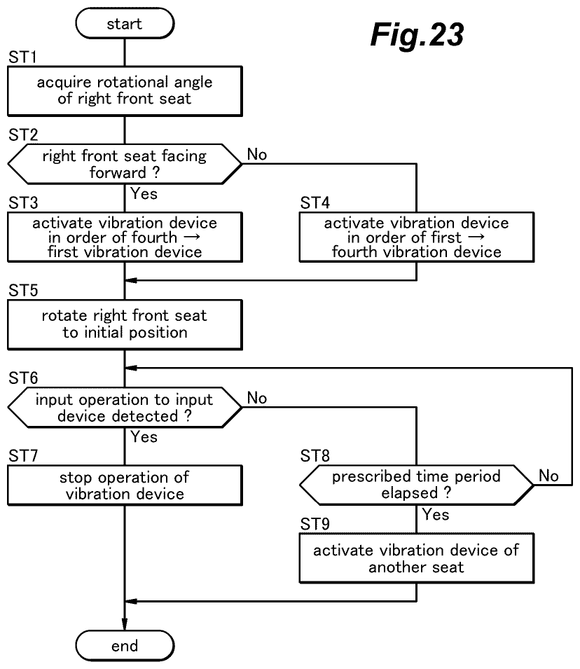

The vehicle control device 226 outputs a switching start signal to the seat control device 225 at the start of the automatic driving end control for switching the driving mode from the automatic driving mode to the manual driving mode. When the seat control device 225 receives the switching start signal, the notification control shown in FIG. 23 is started.

As shown in FIG. 23, the seat control device 225 first obtains the rotational angle of the right front seat 202A based on a signal from the rotational angle sensor 231 of the right front seat 202A (ST1). Based on the rotational angle of the right front seat 202A, the seat control device 225 judges if the right front seat 202A faces forward (ST2) or not. The seat control device 225 may judge that the right front seat 202A faces forward when the rotational angle of the right front seat 202A is between −90 degrees and 90 degrees.

If the right front seat 202A faces forward (the determination result in ST2 is Yes), the seat control device 225 vibrates each vibration device 220 in the order of the fourth vibration devices 220D, the third vibration devices 220C, the second vibration devices 220B, and the first vibration devices 220A (ST3). In other words, the seat control device 225 vibrates the vibration devices 220 in order from the rear ones in the longitudinal direction of the vehicle 201. When the rotational angle is −90 degrees or 90 degrees, the first to fourth vibration devices 220A, 220B, 220C, and 220D are arranged at the same position in the longitudinal direction of the vehicle 201. For example, the seat control device 225 may vibrate the fourth vibration devices 220D for a predetermined period and then stop them, vibrate the third vibration devices 220C for a predetermined period and then stop them, vibrate the second vibration devices 220B for a predetermined period and then stop them, and vibrate the first vibration devices 220A for a prolonged period. In addition, the seat control device 225 may vibrate the first vibration devices 220A for a predetermined period, and then vibrate the first to fourth vibration devices 220A, 220B, 220C, and 220D for a prolonged period of time.

When the right front seat 202A faces rearward (the determination result of ST2 is No), the seat control device 225 vibrates the vibration devices 220 in the order of the left and right first vibration devices 220A, the left and right second vibration devices 220B, the left and right third vibration devices 220C, and the left and right fourth vibration device 220D (ST4). In other words, the seat control device 225 vibrates the vibration devices 220 in the order from the ones located at the rear in the longitudinal direction of the vehicle 201. For example, the seat control device 225 may vibrate the first vibration devices 220A for a predetermined period and then stop them, vibrate the second vibration devices 220B for a predetermined period and then stop them, vibrate the third vibration devices 220C for a predetermined period and then stop then, and vibrate the fourth vibration device 220D for a prolonged period. Furthermore, the seat control device 225 may vibrate the fourth vibration devices 220D for a predetermined period of time, and then vibrate the first to fourth vibration devices 220A, 220B, 220C, and 220D for a prolonged period.

Then, the seat control device 225 drives the rotation device 211 so that the right front seat 202A faces forward (ST5). The seat control device 225 may control the rotation device 211 until the rotational angle of the right front seat 202A becomes 0 degrees. If the rotational angle of the right front seat 202A is already 0 degrees, the seat control device 225 does not drive the rotation device 211. This allows the occupant seated in the right front seat 202A to perform manual driving operations and prepare for manual driving.

Then, the seat control device 225 determines if a predetermined input operation has been applied to the input device 253 (ST6). The predetermined input to the input device 253 may be a gripping operation of the steering wheel 241, a steering operation of the steering wheel 241, a stepping operation of the accelerator pedal 242, or a stepping operation of the brake pedal 243. The seat control device 225 may determine if a predetermined input operation has been applied to the input device 253 or not based on the signal from the grip sensor 252, the steering angle sensor 245, the accelerator pedal sensor 246, or the brake pedal sensor 247. The signal from the grip sensor 252, the steering angle sensor 245, the accelerator pedal sensor 246, or the brake pedal sensor 247 may be directly inputted to the seat control device 225. Furthermore, the signal from the grip sensor 252, the steering angle sensor 245, the accelerator pedal sensor 246, or the brake pedal sensor 247 may be inputted to the seat control device 225 via the vehicle control device 226. For example, the vehicle control device 226 may output a detection signal to the seat control device 225 based on the signal from the grip sensor 252, the steering angle sensor 245, the accelerator pedal sensor 246, or the brake pedal sensor 247, and the seat control device 225 may determine if a predetermined input operation has been applied to the input device 253 based on the detection signal.

If a predetermined input operation has been applied to the input device 253 (the determination result in ST6 is Yes), the seat control device 225 stops the vibration of the first to fourth vibration devices 220A, 220B, 220C, and 220D (ST7).

If a predetermined input operation has not been applied to the input device 253 (the determination result in ST6 is No), the seat control device 225 determines if a predetermined period has elapsed since the vibration devices 220 started vibrating (ST8). The seat control device 225 may measure the time from the start of vibration of the vibration devices 220 that started vibrating last among the vibration devices 220. Furthermore, the seat control device 225 may measure the time from the start of the notification control, instead of measuring the time from the start of vibration of the vibration devices 220.

If a predetermined period has passed since the vibration devices 220 started vibrating (the determination result in ST8 is Yes), the seat control devices 225 vibrate at least one of the vibration devices 220 of the seats 202B to 202E (second seat) other than those of the right front seat 202A (ST9). For example, the seat control device 225 may vibrate the vibration devices 220 of the left front seat 202B for a predetermined period. This makes it possible to notify the occupant seated in the left front seat 202B that the driving mode will be switched from the automatic driving mode to the manual driving mode. As a result, the occupant seated in the left front seat 202B can alert the occupant seated in the driver's seat.

If the predetermined period has not elapsed since the vibration devices 220 started vibrating (the determination result in ST8 is No), the seat control device 225 repeats the process of determining if a predetermined input operation has been applied to the input device 253 or not (ST6).

By using the notification control, the vibration devices 220 vibrate in the order from the rearmost ones, so that the occupant can be alerted to objects in the front. This allows the occupant to recognize that the driving mode of the vehicle 201 has been switched from the vibration of the right front seat 202A. Since the front-rear positions of the vibration devices 220 are obtained based on the rotational angle of the right front seat 202A, the front-rear positions of the vibration devices 220 can be reliably acquired even if the right front seat 202A is rotated by the rotation device 211.

Since the multiple vibration devices 220 are provided on the seat cushion 205 and the seat back 206 of the right front seat 202A, the distance between the frontmost vibration device 220 and the rearmost vibration device 220 can be increased. This increases the moving distance of the vibration position, making it easier for the occupant to recognize that the vibration position has changed.

The seat control device 225 can estimate that the occupant has completed preparation for the manual driving mode based on the input by the occupant to the input device 253. In addition, when the occupant has completed preparation for the manual driving mode, the vibration of the vibration device 220 can be stopped to avoid unnecessary energy consumption.

The seat control device 225 may execute an additional control to control the multiple vibration devices 220 based on audio information. More specifically, the seat control device 225 may vibrate the vibration devices 220 based on audio information in the same way as the speaker 255. In this case, the seat control device 225 may reduce the amplitude of the output of the vibration devices 220 by the additional control when the notification control is being executed, as compared to when the notification control is not being executed. According to this aspect, when the driving mode is switched, the amplitude by the additional control is suppressed, so that the occupant can easily recognize the vibration by the notification control.

The seat control device 225 may execute an obstacle control to control the vibration devices 220 according to the position of the obstacle. The drive control device may obtain the position of an obstacle based on a signal from the obstacle sensor 251, and output the position information of the obstacle to the seat control device 225. The seat control device 225 may vibrate the vibration device 220 located close to the obstacle based on the position information of the obstacle. For example, when the seat 202 faces forward and the obstacle is in the right front of the vehicle 201, the seat control device 225 may vibrate the first vibration device 220A on the right side. Furthermore, when the seat 202 faces forward and an obstacle passes on the right side of the vehicle 201 from the front to the rear, the seat control device 225 may vibrate the first vibration device 220A on the right side, the second vibration device 220B on the right side, the third vibration device 220C on the right side, and the fourth vibration device 220D on the right side, in that order. This allows the occupant to recognize the relative position of the obstacle with respect to the vehicle 201.

The seat control device 225 may prohibit the obstacle control while executing the notification control. According to this aspect, when the driving mode is switched, the seat control device 225 prohibits the obstacle control, so that the occupant can easily recognize the vibration due to the notification control.

The seat control device 225 may execute a preliminary control before executing the notification control, in which the vibration devices 220 are vibrated with an amplitude smaller than the amplitude of the vibration devices 220 in the notification control. According to this aspect, the occupant can recognize that the driving mode is being switched by the vibration based on the preliminary control.

When the reclining angle of the seat back 206 is equal to or greater than a predetermined first determination value, the seat control device 225 may increase the amplitude of the output of the vibration devices 220 compared to when the reclining angle is less than the first determination value in the notification control. According to this aspect, it is possible to give a stronger vibration to the occupant who may be asleep, so that the occupant can recognize the switching of the driving mode.

When the load measured by the load sensor 233 is equal to or greater than a predetermined second determination value in the notification control, the seat control device 225 may increase the amplitude of the output of the vibration devices 220 compared to when the load measured by the load sensor 233 is less than the second determination value. According to this aspect, it is possible to give a stronger vibration to the occupant of a larger build.

This concludes the description of the eighth embodiment, but the present invention is not limited to the above embodiment and can be modified and implemented in widely different ways.

### LIST OF REFERENCE NUMERALS

1: vehicle seat
8: seat cushion frame structure
9A: pad member
18: support member main body (main body)
24: vibration generating device (electrical device)
27: wire harness (linear member)
50: retaining structure
51: first retaining portion
52: second retaining portion
53: first base portion
54: first restricting piece (restricting piece)
55: second base portion
56: second restricting piece (restricting piece)
70: protrusion

1. A vehicle seat, comprising
a frame structure,
a support member supported by the frame structure and supporting an occupant,
a pad member supported on a front side of the support member, and
a wire harness to be connected to an electrical device,
the support member having a plate-shaped main body, and
a retaining structure for retaining the wire harness on the main body,
wherein the retaining structure includes a first retaining portion that connects the wire harness to the main body so as to be movable in a first direction and immobile in a second direction crossing the first direction, and a second retaining portion that connects the wire harness to the main body so as to be movable in the second direction and immobile in the first direction, the retaining structure being integrally formed with the main body.

2. The vehicle seat according to claim 1, wherein the first retaining portion includes a pair of first base portions that protrude from a rear surface of the main body and are aligned in the second direction, and the second retaining portion includes a pair of second base portions that protrude from a rear surface of the main body and are aligned in the first direction, the wire harness being passed between the first base portions and between the second base portions.

3. The vehicle seat according to claim 2, wherein at least one of the first base portions and at least one of the second base portions are connected to each other.

4. The vehicle seat according to claim 2, wherein the first base portions and the second base portions are positioned apart from each other.

5. The vehicle seat according to claim 2, wherein each first base portion is plate-shaped having a surface perpendicular to the second direction, and each second base portion is plate-shaped having a surface perpendicular to the first direction.

6. The vehicle seat according to claim 5, wherein the first base portions are provided at a position spaced apart from the second base portions in both the first direction and the second direction.

7. The vehicle seat according to claim 2, wherein a tip of each of the first base portions and the second base portion is provided with a restricting piece to restrict the wire harness from moving away from the main body.

8. The vehicle seat according to claim 7, wherein the first base portion is plate-shaped having a surface perpendicular to the second direction, and at least one of the first base portions is provided with two or more restricting pieces such that the restricting pieces provided on the one first base portion and the restricting piece provided on the other first base portion are arranged in a staggered manner along the first direction.

9. The vehicle seat according to claim 8, wherein each second base portion is plate-shaped having a surface perpendicular to the first direction, and at least one of the second base portions is provided with two or more restricting pieces such that the restricting pieces provided on the one second base portion and the restricting piece provided on the other second base portion are arranged in a staggered manner along the second direction.

10. The vehicle seat according to claim 2, wherein opposing surfaces of the first base portions are provided with protrusions that protrude in opposing directions, at least one of the first base portions being provided with a plurality of the protrusions such that the protrusions are staggered along the first direction, and the protrusion amount of each protrusion increase as one moves away from the support member.

11. A method for manufacturing a vehicle seat comprising the steps of
installing a pad member on a front side of a support member supported by a frame structure and
installing an electrical device to which a wire harness is connected on the pad member,
the support member having a plate-shaped main body and a retaining structure for retaining the wire harness on the main body,
wherein the retaining structure includes a first retaining portion that connects the wire harness to the main body so as to be movable in a first direction and immobile in a second direction crossing the first direction, and
a second retaining portion that connects the wire harness to the main body so as to be movable in the second direction and immobile in the first direction, and
the step of installing the electrical device includes the steps of retaining the wire harness to the first retaining portion and the second retaining portion.
